(19) United States
(12) Patent Application Publication
(10) Pub. No.: US 2014/0038849 A1
(43) Pub. Date: Feb. 6, 2014

(54) METHOD OF ANALYZING AN ANALYTE USING COMBINATORIAL ARRAYS AND UNIFORM PATTERNS

(71) Applicants: Chad A. Mirkin, Wilmette, IL (US); Louise R. Giam, Palo Alto, CA (US); Matthew D. Massich, Chicago, IL (US)

(72) Inventors: Chad A. Mirkin, Wilmette, IL (US); Louise R. Giam, Palo Alto, CA (US); Matthew D. Massich, Chicago, IL (US)

(73) Assignee: NORTHWESTERN UNIVERSITY, Evanston, IL (US)

(21) Appl. No.: 14/000,129

(22) PCT Filed: Mar. 17, 2012
(86) PCT No.: PCT/US12/29569

§ 371 Date: Oct. 15, 2013

Related U.S. Application Data
(60) Provisional application No. 61/453,937, filed on Mar. 17, 2011.

(51) Int. Cl. B01J 19/00

(52) U.S. Cl. CPC B01J 19/0046
USPC 506/10

(57) ABSTRACT

The disclosure relates to a method of analyzing an analyte that includes forming a combinatorial pattern comprising pattern elements with a plurality of sizes and/or structures on a substrate surface with a tilted pen array, applying an analyte to the combinatorial pattern, and identifying a pattern element size and/or structure having a desired effect on an analyte parameter using the combinatorial pattern. The method further includes forming a uniform pattern comprising pattern elements each having substantially the same size and/or structure corresponding to the identified pattern element size and/or structure, and analyzing the effect of pattern element size and/or structure on the analyte parameter using the uniform pattern.

### CROSS-REFERENCE TO RELATED APPLICATION

The benefit under 35 U.S.C. §119(e) of U.S. Provisional Patent Application No. 61/453,937, filed Mar. 17, 2011, is hereby claimed, and the disclosure is incorporated herein by reference in its entirety.

### STATEMENT OF GOVERNMENTAL INTEREST

This invention was made with government support under grant number FA9550-08-1-0124 awarded by the Air Force Office of Scientific Research (AFOSR), grant number EEC-0647560 awarded by the National Science Foundation Nanoscale Science and Engineering Center (NSF NSEC), grant number N66001-08-1-2044 awarded by the Space and Naval Warfare Systems Center (SPAWARSYSSCEN/DARPA), and grant number CCNE U54 CA151880 awarded by the National Institute of Health/National Cancer Institute (NIH/NCI). The government has certain rights in the invention.

### BACKGROUND

Polymer-pen lithography (PPL) is a molecular printing technology that combines elements of dip-pen nanolithography and microcontact printing to print arbitrary patterns with nanoscale registration between features. See Huo et al., 321 Science 1658-60 (2008); Piner et al., 283 Science 661-63 (1999); Ginger et al., 43 Angew. Chem. Int. Ed. 30-45 (2004); Salaita et al., 2 Nat. Nanotech. 145-55 (2007); Kumar et al., 63 Appl. Phys. Lett. 2002-04 (1993); Xia et al., 99 G. M. Chem. Rev. 1823-48 (1999); Xia et al., 7 Adv. Mater. 471-73 (1995); and Wilbur et al., 7 Adv. Mater. 649-52 (1995). PPL has the ability to print features ranging in edge length from about 90 nm to tens of micrometers in a single writing operation. PPL offers several advantages over DPN, including higher throughput by using a massively parallel array of elastomeric tips (for example up to 10⁷ tips) and the ability to change the feature size using either contact force or dwell time. The ability to vary the feature size by varying the contact force between the tip array and the substrate is a feature unique to PPL and occurs because the elastomeric tips deform upon contact with the surface, thus increasing the contact area and in turn, the feature edge length. Recently, a quantitative relationship between the force between the tip array and the substrate and the resulting feature edge lengths was established and verified experimentally.

A challenge that arose in PPL was obtaining precise leveling between the planes of the pen array and the substrate because it was found that misalignment between the planes of the pen array and the substrate resulted in pens across the array not being in contact with the surface simultaneously and the pens not being deformed identically. Previously, optical methods were used to judge the alignment between the two planes. The optical method included pressing the pens into the surface, and when it appeared that all pens deformed by the same amount when viewed through a microscope, the arrays were judged to be level with respect to the surface. This optical leveling method was only able to level the two planes within 0.01°, which can lead to a large deviation in feature size across a 1×1 cm pen array.

Recently it was determined that by maximizing the force between the pen array and the substrate upon a given z-piezo extension, the two planes could be leveled within 1×10⁻⁴ degree. Using this force feedback leveling strategy, features of 16-mercaptohexadecanoic acid were written on a gold surface with a size variance of less than 2% over a distance of 1 cm. See Liao et al., 10 Nano Lett. 1335-40 (2010). Leveling the array with respect to the substrate uses the previously established relationship between z-piezo extension and force. See Liao et al., 6 Small 1082-85 (2009).

### SUMMARY

In accordance with an embodiment of the disclosure, a method of analyzing an analyte includes applying an analyte to a combinatorial pattern, the combinatorial pattern comprising pattern elements with a plurality of sizes and/or structures formed on a substrate surface using a tilted pen array, and identifying a pattern element size and/or structure having a desired effect on an analyte parameter using the analyte/combinatorial pattern combination. The method can further include applying an analyte to a uniform pattern, the uniform pattern comprising pattern elements each having substantially the same size and/or structure corresponding to the identified pattern element size and/or structure formed on a substrate surface using a level pen array. The method can further include analyzing an effect of that pattern element size and/or structure on the analyte parameter using the analyte/uniform pattern combination by comparing the analyte parameter across the uniform pattern elements.

In the above-disclosed embodiments, the patterning composition can be an alkanethiol or a protein. The patterning composition can comprise fibronectin, for example, human plasma fibronectin. Alternatively, fibronectin can be immobilized on a surface of the patterning elements.

In accordance with another embodiment of the disclosure, a method of analyzing an analyte includes immobilizing an extracellular matrix protein on pattern elements of a combinatorial pattern array, the combinatorial pattern array comprising pattern elements with a plurality of sizes and/or structures formed on a substrate surface using a tilted pen array, seeding a cell on the combinatorial pattern array elements having the extracellular matrix protein immobilized thereon, and identifying a pattern element size and/or structure having a desired effect on a cell parameter using the seeded combinatorial pattern array. The method further includes immobilizing an extracellular matrix protein on pattern elements of a uniform pattern array, the uniform pattern array comprising pattern elements each having substantially the same size and/or structure corresponding to the identified pattern element size and/or structure, seeding a cell on the uniform pattern array elements having the extracellular matrix protein immobilized thereon. The method can further include analyzing the effect of that pattern element size and/or structure on the cell parameter using the seeded uniform pattern by comparing the cell parameter across the uniform pattern elements.

Depositions of patterns having varying feature sizes can be useful in studying the effects of size on biological processes. The growth and differentiation of stems cells on patterns with different feature sizes can be examined using embodiments of the method disclosed herein. For example, embodiments of the method can include seeding mesenchymal stem cell on the pattern elements and analyzing one or more of mesenchymal stem cell (MSC) differentiation, MSC attachment, MSC viability, and MSC osteogenic marker expression as a function of pattern element size. Analyzing the mesenchymal stem cell differentiation can include analyzing protein and transcription factor markers indicative of osteogenic commitment, for example, alkaline phosphatase, osteocalcin, osteopontin, core-binding factor-α, transcriptional coactivator with PDZ-motif.

In any of the methods disclosed herein, the combinatorial pattern can be formed by choosing a tilt geometry for a pen array with respect to a substrate surface, the tilt geometry being in reference to a substrate surface and comprising a first angle of the pen array with respect to a first axis of the substrate and a second angle of the pen array with respect to a second axis of the substrate, the first and second axes being parallel to the substrate surface and perpendicular to one another, at least one of the first and second angles being non-zero, wherein a leveled position with respect to the substrate surface comprises first and second angles both equaling 0°, inducing the tilt geometry between the pen array and the substrate surface by the chosen first and second angles; and forming a pattern having pattern elements on the substrate surface with the titled pen array, whereby the size of the formed pattern elements varies across the substrate surface along the tilted axis or axes. The pen array includes a plurality of tips fixed to a common substrate layer, the tips and the common substrate layer are formed from an elastomeric polymer or elastomeric gel polymer, and the tips have a radius of curvature of less than about 1 μm.

Alternatively, in either of the above-disclosed embodiments, the combinatorial pattern can be formed by choosing a range of pattern element sizes for a pattern formed on a substrate surface and choosing, based on a theoretical model, a tilt geometry for a pen array with respect to the substrate surface to achieve the chosen range of pattern element sizes, the tilt geometry being in reference to a substrate surface and comprising a first angle of the pen array with respect to a first axis of the substrate and a second angle of the pen array with respect to a second axis of the substrate, the first and second axes being parallel to the substrate surface and perpendicular to one another, at least one of the first and second angles being non-zero, wherein a leveled position with respect to the substrate surface comprises first and second angles both equaling 0°, inducing the tilt geometry between the pen array and the substrate surface by the chosen first and second angles, and forming the pattern having pattern elements on the substrate surface with the titled pen array, whereby the size of the formed pattern elements varies across the substrate surface along the tilted axis or axes and comprise the chosen range of pattern element sizes. The pen array includes a plurality of tips fixed to a common substrate layer, the tips and the common substrate layer being formed from an elastomeric polymer or elastomeric gel polymer, and the tips having a radius of curvature of less than about 1 μm.

In any of the embodiments of the method the uniform pattern can be formed using a level pen array. The pen array used to form the combinatorial pattern can also be used to form the uniform pattern.

### BRIEF DESCRIPTION OF THE DRAWINGS

FIG. 1a is a schematic drawing of a pyramidal tip of a polymer pen tip array;

FIG. 1b is a schematic drawing illustrating an unleveled polymer pen array with arbitrary angles θ and φ between the pen array and the surface, the black pen illustrating the initial point of contact;

FIG. 2a is a graph showing the predicted total force as a function of tilting angles (θ, φ) for a 1 cm×1 cm pen array with 80 μm pitch between pens;

FIG. 2b is a graph showing the difference between the maximum and minimum feature size as a function of tilt for a 1 cm×1 cm pen array with 80 μm pitch between pens;

FIGS. 3a-3b are scanning electron microscopy (SEM) images showing patterns made by a 10,000 pen array with (a) θ=0°, (b) θ=0.01°, and (c) θ=−0.01°;

FIG. 3d is a graph illustrating the relationship between feature size and distance along the pen array as a function of different leveling conditions;

FIG. 3e is a graph illustrating the diameters of different feature sizes for different leveling conditions, normalized to the θ=0° leveling condition;

FIG. 4 is a graph illustrating the distribution of calculated feature size as a function of tilting angles (θ, φ) for a 20×20 pen array with 500 μm pitch between pens and a z-piezo extension of about 12 μm;

FIG. 5a is a scanning electron microscopy image of several arrays of gold nanoparticles printed using a tilted pen array, the inset shows a single array;

FIG. 5b is a scanning electron microscopy image of one portion of an array of FIG. 5a, the inset shows the size of a single gold nanoparticle;

FIG. 6 is a schematic drawing illustrating the variation in feature size in patterns written on a substrate deposited by a deliberately tilted polymer pen array;

FIG. 7 is an optical micrograph of an MHA pattern printed on gold using a tilted polymer pen array in accordance with an embodiment of the method of the disclosure;

FIG. 8A is an optical microscope image of a polymer pen array wherein the spacing between pens is 80 μm×80 μm;

FIG. 8B is an optical microscope image of polymer pen array wherein the spacing between pens 180 μm×180 μm;

FIG. 9A is a fluorescence microscopy image of a stem cell grown on a surface displaying a combinatorial pattern of different sized features of fibronectin;

FIG. 9B is a fluorescence microscopy image of the stem cell of FIG. 9A;

FIG. 9C is a fluorescence microscopy image of the combinatorial pattern of different sized features of fibronectin of FIG. 89;

FIGS. 10a-10c are graphs illustrating a method of leveling a polymer pen array, and specifically FIG. 10a is a graph illustrating the total force measurements resulting from tilting the pen array to vary p, while holding θ constant, until a local maximum in total force is found; FIG. 10b is a graph illustrating the total force measurements resulting from tilting the pen array to vary θ, while holding φ constant, until a local maximum in total force is found; and FIG. 10c is a graph illustrating the total force measurements resulting from tilting of the pen array to vary φ, while again holding θ constant until a global maximum in total force is found; FIG. 10d is a three-dimensional plot constructed from the graphs of FIGS. 10a-10c;

FIG. 11A is a schematic illustration of a tilted polymer pen array, which can be used to generate combinatorial pattern arrays in accordance with embodiments of the disclosure;

FIG. 11B is an SEM image of a combinatorial pattern formed using a tilted polymer pen array as illustrated in FIG. 11A;

FIG. 11C is a schematic illustration of a level pen array, which can be used to generate a uniform pattern having elements of the same feature size;

FIG. 11D is an SEM image of a uniform pattern having uniform feature sizes formed by a level polymer pen array as illustrated in FIG. 11C;

FIG. 11E is a graph illustrating the gradient in feature size of a combinatorial pattern generated by tilting a pen array 0.01°; feature sizes range from 3.7 μm to about 800 μm;

FIG. 11F is an SEM image of Au features having a diameter of about 300 nm made by chemical etching a portion of a substrate having PPL-patterned MHA features, using an aqueous solution of 13.3 mM Fe(NO₃)₃.9H₂O and 20 mM thiourea;

FIGS. 12A and 12B are schematic illustrations of a method immobilizing fibronectin and culturing cells on a patterned substrate in accordance with embodiments of the disclosure;

FIG. 12C is an AFM topography image of a patterned substrate after fibronectin immobilization, showing that a monolayer of protein (height of about 2.2 nm) is adsorbed;

FIG. 12D is an AFM phase image of a pattern substrate after fibronectin immobilization, showing that each MHA feature is completely covered with adsorbed fibronectin;

FIG. 13A is a large area fluorescence image of fibronectin patterns (feature size=1 μm, pitch=4 μm) stained with mouse anti-fibronectin antibody and AlexaFluor488-conjucated goat anti-mouse;

FIG. 13B is a phase contrast optical microscopy image of MSCs seeded on fibronectin patterns (feature size=1 μm, pitch=4 μm);

FIG. 13C is a fluorescence microscope image at 50× magnification of fibronectin patterns shown in FIG. 13A. The patterns were made using a pen array having a 80×80 μm pen spacing and labeled with mouse anti-fibronectin antibody and AlexaFluor488-conjucated goat anti-mouse IgG;

FIG. 14 are quantitative RT-PCR results for performed on the patterns of FIG. 13B for (A) alkaline phosphatase, (B) osteocalcin, and (C) core-binding factor α (CBF-α) normalized to GAPDH levels. Samples were normalized to the negative control (OM−NP) and are presented as the mean±standard deviation, n=3; statistics were conducted using Student's two-tailed t-test where asterisks indicate statistically significant differences relative to the negative control (OM−NP): *p<0.05, **p<0.001;

FIG. 15 is western blotting results for ALP and CPF-α, with GAPDH used as the loading control performed on the patterns of FIG. 13B;

FIG. 16 is confocal microscopy images of immunofluorescence stained samples of MSCs cultured in a negative control (OM−NP), a positive control (OM+NP), and on patterns having a pattern size of 1 μm or 300 nm in the absence of OM (OM−); showing the presence of osteogenic marker alkaline phosphatase in MSCs;

FIG. 17A is a schematic illustration of the proposed signaling pathway by which integrin-dependent MSC cell adhesion leads to osteogenesis;

FIG. 17B are ELISA results for FAK (white) and phosphorylated (Tyr397) FAK (grey) normalized to the negative control (OM−NP). The relative amounts of FAK are statistically the same for all samples; increased relative amounts of phosphorylated FAK are shown for the positive control (OM+NP) and for MSCs cultured on patterned substrates (1 μm and 300 nm features in the presence and absence of OM). Results are presented as the mean±standard deviation, n=3; statistics were conducted using Student's two-tailed t-test where asterisks indicate statistically significant differences relative to the negative control (OM−NP): *p<0.05; and

FIG. 18 is an immunofluorescence image of MSCs cultured on combinatorial fibronectin patterns; labels (4589, 5283, 5506, 6034, 6627, and 7014 km) indicate x-position across the patterned substrate and correspond to a certain protein feature.

### DETAILED DESCRIPTION

Deliberate tilting of a pen array, for example, a polymer or gel pen array, before printing can allow high-throughput combinatorial arrays of varying feature size to be quickly fabricated. Methods of the disclosure advantageously utilize such combinatorial arrays (also referred to herein as “combinatorial patterns”) to quickly and rapidly analyze a large number of feature sizes, pattern densities, and/or compositions to identify relevant feature sizes, pattern densities, and/or compositions, and for analyzing the effect of feature size (also referred to herein as pattern size), pattern densities, and/or compositions on an analyte parameter. Generally, methods of the disclosure include the analysis of the effect of feature size, pattern density, and/or composition on an analyte and specifically a feature, process, and/or interaction of the analyte (hereinafter “analyte parameter”) using a combinatorial array to identify relevant feature sizes, pattern densities, and/or composition, and a uniform pattern having pattern elements with the identified feature sizes, pattern densities, and/or compositions to analyze how those feature sizes, pattern densities, and/or compositions effect the analyte parameter. In accordance with embodiments of the disclosure, a combinatorial array of pattern sizes can be used as a rapid screening method to identify, qualitatively, pattern features of interest, while the uniform pattern can be used for more detailed and/or quantitative analysis of the effect on the limited (identified) features. The methods of the disclosure, thus, advantageously further allow for performance of the more detailed and often more time and cost intensive analysis on only those feature sizes having relevance or effect on the analyte parameter.

The analyte parameter can include, for example, any biological processes, including but not limited to cell differentiation, cell attachment, cell viability, and cell osteogenic marker expression. For example, embodiments of the methods of the disclosure can be used to analyze how biomolecular and physical composition of the surrounding cellular environment affects fundamental cell processes. For example, the effect of the surrounding environment on stem cell differentiation, cancer cell metastasis, neuron signaling, embryonic development, and tissue engineering can be studied using methods in accordance with the disclosure. It is also contemplated, herein, that the methods can be used to analyze non-biological processes or interactions, including but not limited to chemical interactions, such as catalysis or analyte detection, and processes, including but not limited to optical, electrical, magnetic phenomena relevant to meta-materials, energy-harvesting, circuit design, and plasmonics.

For example, in the context of the study of mesenchymal stem cell (MSC) differentiation, combinatorial arrays can be used to screen a large number of feature sizes to qualitatively identify feature sizes that have an effect on differentiation (e.g., feature sizes suitable for MSC attachment). Patterns having uniform feature size (corresponding to the identified feature size) can then be used to analyze, for example, quantitatively, the effect that each of the identified (pre-screened) feature sizes has on cell differentiation. For example, uniform patterns having an identified feature size can be used to allow for quantification of mRNA and protein expression in statistically significant populations of cells.

In contrast to conventional methods, such as micro-contact printing, the method of the disclosure allows for rapid productions of arrays of features sizes, with precise control over feature size, spacing, pattern design, and composition. This in turn allows for a cost effective method of identifying a feature size or a plurality of feature sizes having relevance on the analyte parameter of interest. Micro-contact printing requires the production of new masks for forming the micro contact printing mold each time a change in feature sizes, spacing, or gradient of feature sizes is desired. In contrast, the polymer pen array and methods of patterning described herein allow for changes in feature size and feature size gradients simply by manipulation of the angle of the tilted array and/or the pressure applied to deform the tips. Additionally, the same pen array can be used in a tilted configuration to generate libraries having tunable combinatorial feature sizes between the nano- to micron-scale to determine particular feature sizes of interest, and in a level configuration to prepare patterns homogeneous (also referred to herein as “uniform patterns”) over larger areas for further investigation of statistically significant populations of analytes.

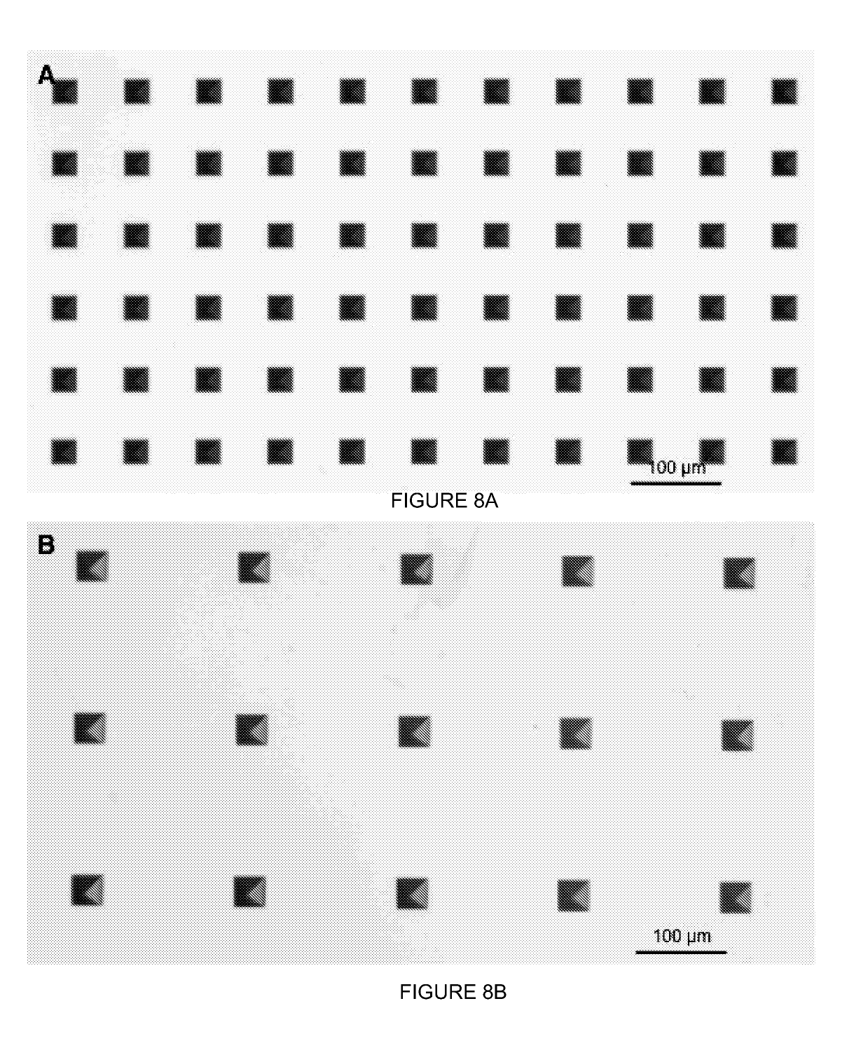

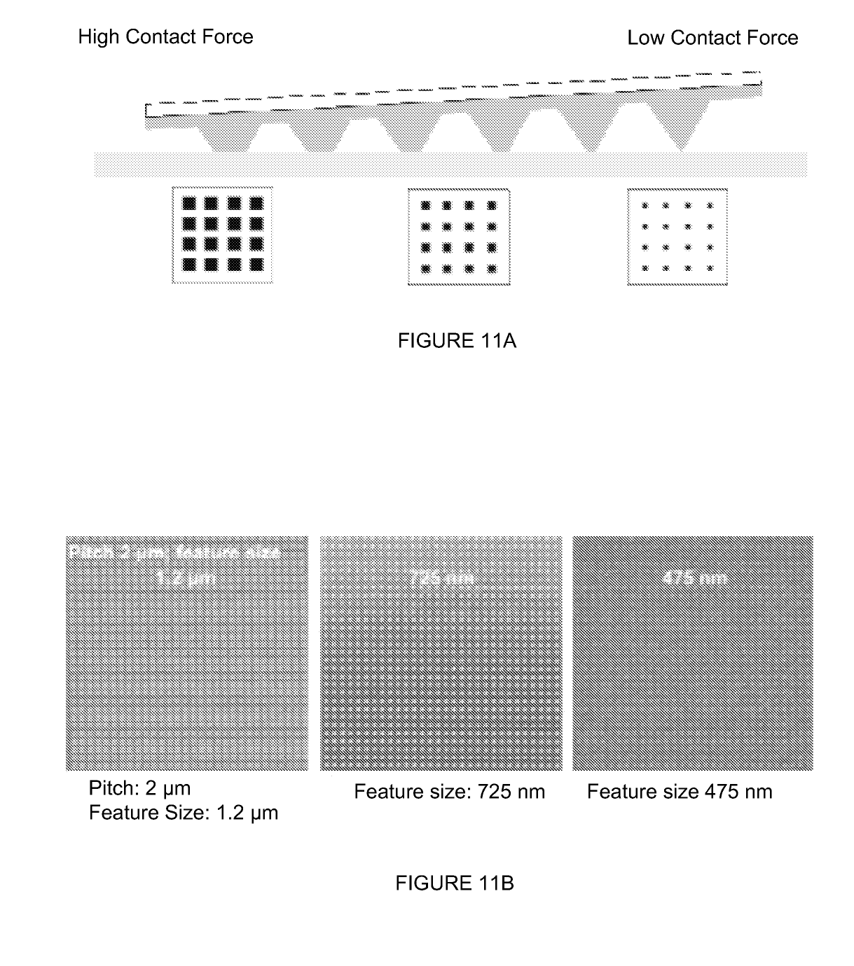

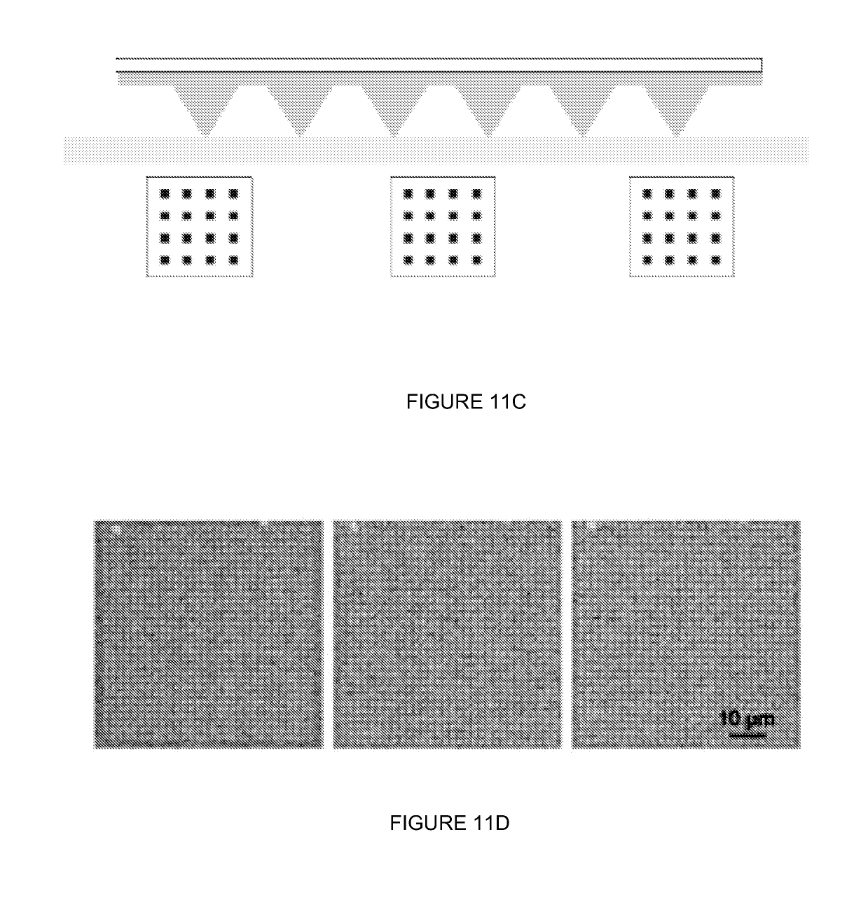

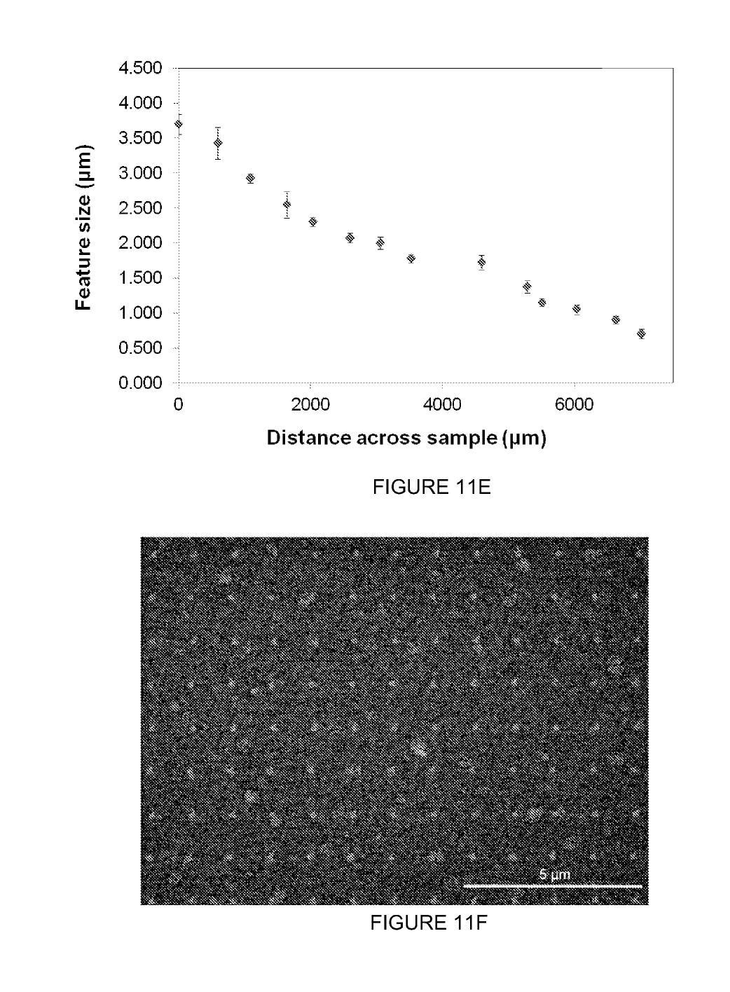

FIGS. 11A and 11B illustrate forming a combinatorial array using a tilted pen array. FIG. 11E is a graph illustrating a feature size gradient that can be achieved with a tilted pen array. FIGS. 11C and 11D illustrate forming a uniform pattern using a level pen array. FIG. 11F illustrates a pattern having uniform feature sizes formed using a level pen array. FIGS. 8A and 8B illustrate pen arrays having different pen spacing, which as described below can allow for formation of patterns having the same pattern density, but different pattern sizes.

### Patterning

The tips of the pen array can be made to deform with successively increasing amounts of applied pressure, which can be controlled by simply extending the piezo in the vertical direction (z-piezo). Controlled deformation of the tips of the pen array can be used as an adjustable variable, allowing one to control tip-substrate contact area and resulting feature size. The variance in feature size occurs because the tilt between the pen array and the substrate causes each of the pens to deform differently upon z-piezo extension, which results in features of different dimensions being produced. By controlling the deformation of the pens across the pen array through tilting of the array, control and variance of feature size produced by pens across the pen array can be achieved.

Any polymer pen lithography method can be used in the method of the present disclosure depending on the ink to be printed on the substrate. For example, Polymer Pen Lithography, Gel Pen Lithography, and Beam Pen Lithography can be used in the method of the present disclosure. For a description of Polymer Pen Lithography see International Patent Publication No. WO 2009/132321, the entire disclosure of which is incorporated herein by reference. For a description of Gel Pen Lithography see International Patent Application No. PCT/US2010/024631, the entire disclosure of which is incorporated herein by reference. For a description of Beam Pen Lithography see International Patent Application No. PCT/US2010/024633, the entire disclosure of which is incorporate herein by reference. For example, by using matrix-assisted polymer pen lithography (see Huang et al., 6 Small 1077-81 (2010)), the method of the present disclosure can be used to print various inorganic materials.

A defining characteristic of polymer pen lithography, in contrast with DPN and most contact printing strategies, which are typically viewed as pressure or force-independent, is that it exhibits both time- and pressure-dependent ink transport. As with DPN, features made by polymer pen lithography can exhibit a size that is linearly dependent on the square root of the tip-substrate contact time. This property of polymer pen lithography, which is a result of the diffusive characteristics of the ink and the small size of the delivery tips, allows one to pattern sub-micron features with high precision and reproducibility (variation of feature size is less than 10% under the same experimental conditions). The pressure dependence of polymer pen lithography derives from the deformable or compressible nature of the elastomer pyramid array. Indeed, the microscopic, preferably pyramidal, tips can be made to deform with successively increasing amounts of applied pressure, which can be controlled by simply extending the piezo in the vertical direction (z-piezo). Although such deformation has been regarded as a major drawback in contact printing (it can result in “roof” collapse and limit feature size resolution), with polymer pen lithography, the controlled deformation can be used as an adjustable variable, allowing one to control tip-substrate contact area and resulting feature size. Within a pressure range allowed by z-piezo extension of about 5 to about 25 m, one can observe a near linear relationship between piezo extension and feature size at a fixed contact time. When the z-piezo extends 1 μm or more, the tips exhibit a significant and controllable deformation.

Beam Pen Lithography (BPL) can allow for patterning of sub-micron features over large areas with flexible pattern design, convenient, selective pen tip addressability, and low fabrication cost. As compared to conventional photolithography or contact printing in which only pre-formed patterns (i.e. photomasks) can be duplicated, BPL can provide the flexibility to create different patterns by controlling the movement of a pen array over the substrate and/or by selectively illuminating one or more of the tips in the pen array. Thus, multiple “dots”, for example, can be fabricated to achieve arbitrary features. This approach bypasses the need for, and costs associated with, photomask fabrication in conventional photolithography, allowing one to arbitrarily make many different types of structures without the hurdle of designing a new master via a throughput-impeded serial process. An embodiment of BPL generally includes contacting a photosensitive substrate, for example, a substrate having a photosensitive layer coated thereon, with a pen array and irradiating a surface of a pen array with a radiation source, such as, for example, UV light. The pen array generally includes tips having a blocking layer disposed on the sidewalls of the tips and an aperture formed therein exposing the tip end. As a result of the blocking layer blocking the radiation (e.g., by reflection), the radiation is transmitted through the transparent polymer and out the portion of the transparent polymer exposed by the aperture (i.e., the tip end). Patterning using the transmitted radiation can be performed in a contact mode, in which the pen array is brought into contact with the substrate surface, or in a non-contact mode, in which the pen array is brought near the substrate surface, or in a combination thereof in which a subset of one or more pens in the pen array is brought into contact with the substrate surface. In principle, the type of radiation used with the Beam Pen Lithography is not limited. Radiation in the wavelength range of about 300 nm to about 600 nm is preferred, optionally 380 nm to 420 nm, for example about 365 nm, about 400 nm, or about 436 nm. For example, the radiation optionally can have a minimum wavelength of about 300, 350, 400, 450, 500, 550, or 600 nm. For example, the radiation optionally can have a maximum wavelength of about 300, 350, 400, 450, 500, 550, or 600 nm.

The photosensitive layer disposed on the substrate can be exposed by the radiation transmitted through the polymer tip for any suitable time, for example, in a range of about 1 second to about 1 minute. For example, the minimum exposure time can be about 1, 2, 3, 4, 5, 6, 7, 8, 9, 10, 20, 30, 40, 50, or 60 seconds. For example, the maximum exposure time can be about 1, 2, 3, 4, 5, 6, 7, 8, 9, 10, 20, 30, 40, 50, or 60 seconds.

The photosensitive layer can be developed, for example, by any suitable process known in the art. For example, when a resist layer is used, the exposed resist layer can be developed for about 30 seconds in MF319 (Rohm & Haas Electronic Materials LLC). The resist layer can be a positive resist or a negative resist. If a positive resist layer is used, developing of the resist layer removes the exposed portion of the resist layer. If a negative resist layer is used, developing of the resist layer removes the unexposed portion of the resist layer. Optionally, Beam Pen Lithography can further include depositing a patterning layer on the substrate surface after exposure followed by lift off of the resist layer to thereby form the patterning layer into the indicia printed on the resist layer by BPL. The patterning layer can be a metal, for example, and can be deposited, for example, by thermal evaporation. The resist lift off can be performed using, for example, acetone.

### Polymer Pen Arrays

As used herein, the term “polymer pen arrays” generally refers to pen arrays for use in any polymer pen lithography method including, but not limited to, Polymer Pen Lithography, Gel Pen Lithography, and Beam Pen Lithography. Polymer pen arrays generally include elastomeric tips without cantilevers to deliver ink to a printing surface or otherwise pattern a substrate surface. The tips are preferably made of polydimethylsiloxane (PDMS) or agarose gel. For Beam Pen Lithography, the tips are formed from a material which is at least translucent to the wavelength of radiation intended for use in patterning, e.g., in a range of 300 nm to 600 nm.

A polymer pen array can include any number of tips, preferably having a pyramidal shape, which can be made by molding with a master prepared by conventional photolithography and subsequent wet chemical etching. Contemplated numbers of tips include about 1000 tips to about 15 million tips, or greater. The number of tips of the polymer pen array can be greater than about 1 million, greater than about 2 million, greater than about 3 million, greater than about 4 million, greater than 5 million tips, greater than 6 million, greater than 7 million, greater than 8 million, greater than 9 million, greater than 10 million, greater than 11 million, greater than 12 million, greater than 13 million, greater than 14 million, or greater than 15 million tips. When the sharp tips of the polymer pens are brought in contact with a substrate, ink is delivered at the points of contact.

The tips can be designed to have any shape or spacing between them, as needed. The shape of each tip can be the same or different from other tips of the array. Contemplated tip shapes include spheroid, hemispheroid, toroid, polyhedron, cone, cylinder, and pyramid (trigonal or square). The tips are sharp, so that they are suitable for forming submicron patterns, e.g., less than about 500 nm. For example, the tip ends can have a diameter in a range of about 50 nm to about 1 μm. For example, the minimum diameter can be about 50, 55, 60, 65, 70, 75, 80, 85, 90, 95, 100, 150, 200, 250, 300, 350, 400, 450, 500, 550, 600, 650, 700, 750, 800, 850, 900, 950, or 1000 nm. For example, the maximum diameter can be about 50, 55, 60, 65, 70, 75, 80, 85, 90, 95, 100, 150, 200, 250, 300, 350, 400, 450, 500, 550, 600, 650, 700, 750, 800, 850, 900, 950, or 1000 nm. The sharpness of the tip is measured by its radius of curvature, and the radius of curvature of the tips disclosed herein is below 1 μm, and can be less than about 0.9 μm, less than about 0.8 μm, less than about 0.7 μm, less than about 0.6 μm, less than about 0.5 μm, less than about 0.4 μm, less than about 0.3 μm, less than about 0.2 μm, less than about 0.1 μm, less than about 90 nm, less than about 80 nm, less than about 70 nm, less than about 60 nm, or less than about 50 nm.

The tips of the pen array can be designed to have any desired thickness, for example, the thickness of the tip array is about 50 nm to about 50 μm, about 10 μm to about 50 μm, about 50 nm to about 1 μm, about 50 nm to about 500 nm, about 50 nm to about 400 nm, about 50 nm to about 300 nm, about 50 nm to about 200 nm, or about 50 nm to about 100 nm. For example, the minimum thickness can be about 50 nm, 60 nm, 70 nm, 80 nm, 90 nm, 100 nm, 200 nm, 300 nm, 400 nm, 500 nm, 600 nm, 700 nm, 800 nm, 900 nm, 1 μm, 5 μm, 10 μm, 15 μm, 20 μm, 25 μm, 30 μm, 35 μm, 40 μm, 45 μm, or 50 μm. For example, the maximum thickness can be about 50 nm, 60 nm, 70 nm, 80 nm, 90 nm, 100 nm, 200 nm, 300 nm, 400 nm, 500 nm, 600 nm, 700 nm, 800 nm, 900 nm, 1 μm, 5 μm, 10 μm, 15 μm, 20 μm, 25 μm, 30 μm, 35 μm, 40 μm, 45 μm, or 50 μm. The thickness of the pen array can be decreased as the rigidity of the polymer used to form the tip substrate layer increases. For example, for a gel polymer (e.g., agarose), the tip array can have a thickness in a range of about 10 μm to about 50 μm. For other polymers (e.g., PDMS), for example, the tip array can have a thickness of about 50 nm to about 1 μm. As used herein, the thickness of the tip array refers to the distance from the tip end to the base end of a tip. The tips can be arranged randomly or in any pattern, including a regular periodic pattern (e.g., in columns and rows, in a circular or radial pattern, or the like). The tips have a base portion fixed to the tip substrate layer. The base portion preferably is larger than the tip end portion. The base portion can have an edge length in a range of about 1 μm to about 50 μm, or about 5 μm to about 50 μm. For example, the minimum edge length can be about 1, 2, 3, 4, 5, 6, 7, 8, 9, 10, 11, 12, 13, 14, 15, 16, 17, 18, 19, 20, 22, 24, 26, 28, 30, 32, 34, 36, 38, 40, 42, 44, 46, 48, or 50 μm. For example, the maximum edge length can be about 1, 2, 3, 4, 5, 6, 7, 8, 9, 10, 11, 12, 13, 14, 15, 16, 17, 18, 19, 20, 22, 24, 26, 28, 30, 32, 34, 36, 38, 40, 42, 44, 46, 48, or 50 μm. The tip array is preferably formed such that the tip ends lie in a single plane, although alternative arrangements are also contemplated.

The polymers suitable for use in the pen array can be any polymer having a compressibility and/or deformability compatible with the lithographic methods. In one embodiment, the polymer is deformable; in another embodiment the polymer is compressible. Polymeric materials suitable for use in the pen array can have linear or branched backbones, and can be crosslinked or non-crosslinked, depending upon the particular polymer and the degree of compressibility desired for the tip. Cross-linkers refer to multi-functional monomers capable of forming two or more covalent bonds between polymer molecules. Non-limiting examples of cross-linkers include trimethylolpropane trimethacrylate (TMPTMA), divinylbenzene, di-epoxies, tri-epoxies, tetra-epoxies, di-vinyl ethers, tri-vinyl ethers, tetra-vinyl ethers, and combinations thereof.

Thermoplastic or thermosetting polymers can be used, as can crosslinked elastomers. In general, the polymers can be porous and/or amorphous. A variety of elastomeric polymeric materials are contemplated, including polymers of the general classes of silicone polymers and epoxy polymers. Polymers having low glass transition temperatures such as, for example, below 25° C. or more preferably below −50° C., can be used. Diglycidyl ethers of bisphenol A can be used, in addition to compounds based on aromatic amine, triazine, and cycloaliphatic backbones. Another example includes Novolac polymers. Other contemplated elastomeric polymers include methylchlorosilanes, ethylchlorosilanes, and phenylchlorosilanes, polydimethylsiloxane (PDMS). Other materials include polyethylene, polystyrene, polybutadiene, polyurethane, polyisoprene, polyacrylic rubber, fluorosilicone rubber, and fluoroelastomers.

Further examples of suitable polymers that may be used to form a tip can be found in U.S. Pat. No. 5,776,748; U.S. Pat. No. 6,596,346; and U.S. Pat. No. 6,500,549, each of which is hereby incorporated by reference in its entirety. Other suitable polymers include those disclosed by He et al., Langmuir 2003, 19, 6982-6986; Donzel et al., Adv. Mater. 2001, 13, 1164-1167; and Martin et al., Langmuir, 1998, 14-15, 3791-3795. Hydrophobic polymers such as polydimethylsiloxane can be modified either chemically or physically by, for example, exposure to a solution of a strong oxidizer or to an oxygen plasma.

Alternatively, the polymer of the tip array can be a polymer gel. The polymer gel can comprise any suitable gel, including hydrogels and organogels. For example, the polymer gel can be a silicone hydrogel, a branched polysaccharide gel, an unbranched polysaccharide gel, a polyacrylamide gel, a polyethylene oxide gel, a cross-linked polyethylene oxide gel, a poly(2-acrylamido-2-methyl-1-propanesulfonic acid) (polyAMPS) gel, a polyvinylpyrrolidone gel, a cross-linked polyvinylpyrrolidone gel, a methylcellulose gel, a hyaluronan gel, and combinations thereof. For example, the polymer gel can be an agarose gel. By weight, gels are mostly liquid, for example, gels can be greater than 95% liquid, yet behave like solids due to the presence of a cross-linked network within the liquid. The gel polymer can be, for example, hydrophilic and/or porous, allowing for absorption of a pattern composition.

The polymer of the pen array has a suitable compression modulus and surface hardness to prevent collapse of the polymer during inking and printing, but too high a modulus and too great a surface hardness can lead to a brittle material that cannot adapt and conform to a substrate surface during printing. As disclosed in Schmid, et al., Macromolecules, 33:3042 (2000), vinyl and hydrosilane prepolymers can be tailored to provide polymers of different modulus and surface hardness. Thus, in some cases, the polymer is a mixture of vinyl and hydrosilane prepolymers, where the weight ratio of vinyl prepolymer to hydrosilane crosslinker is about 5:1 to about 20:1, about 7:1 to about 15:1, or about 8:1 to about 12:1.

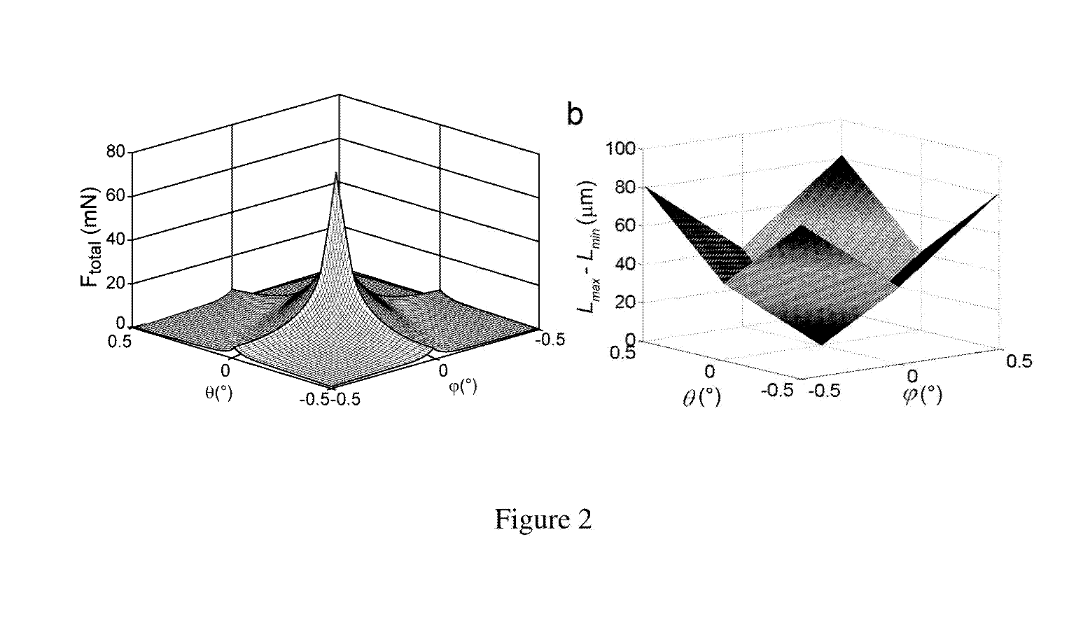

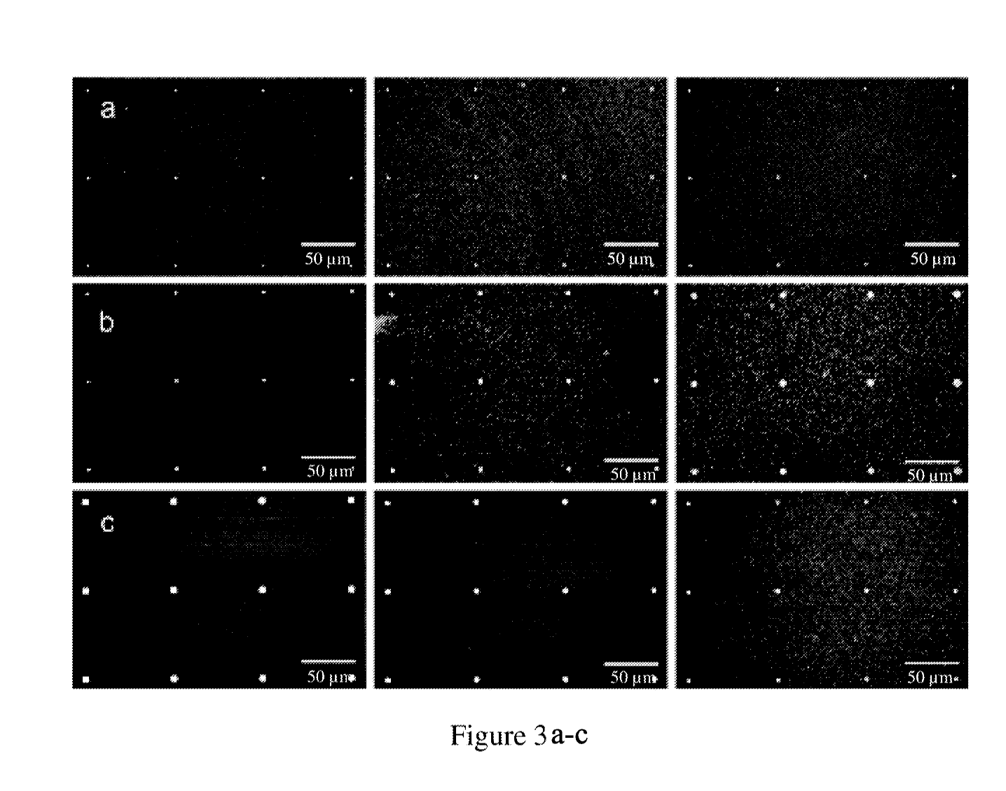

The polymers of the pen array preferably will have a surface hardness of about 0.2% to about 3.5% of glass, as measured by resistance of a surface to penetration by a hard sphere with a diameter of 1 mm, compared to the resistance of a glass surface (as described in Schmid, et al., Macromolecules, 33:3042 (2000) at p 3044). The surface hardness can be about 0.3% to about 3.3%, about 0.4% to about 3.2%, about 0.5% to about 3.0%, or about 0.7% to about 2.7%. The polymers of the tip array can have a compression modulus of about 10 MPa to about 300 MPa. The pen array preferably comprises a compressible polymer or a deformable polymer which is Hookean under pressures of about 10 MPa to about 300 MPa. The linear relationship between pressure exerted on the pen array and the feature size allows for control of the indicia printed using the disclosed methods and pen arrays (see FIG. 2b).

The pen array can comprise a polymer that has adsorption and/or absorption properties for the patterning composition, such that the tip array acts as its own patterning composition reservoir. For example, PDMS is known to adsorb patterning inks, see, e.g., U.S. Patent Publication No. 2004/228962, Zhang, et al., Nano Lett. 4, 1649 (2004), and Wang et al., Langmuir 19, 8951 (2003).

The tips of the pen array can be fixed to a common substrate. For polymer pen arrays for use with Beam Pen Lithography, the common substrate can be formed of a transparent polymer. The tips can be arranged randomly or in any pattern, including a regular periodic pattern (e.g., in columns and rows, in a circular pattern, or the like). The common substrate can comprise, for example, an elastomeric layer, which can comprise the same polymer that forms the tips of the tip array, or can comprise an elastomeric polymer that is different from that of the tip array. For example, the common substrate can be a gel backing layer. Suitable gels include those described herein in connection with polymer gels for use as tip materials. The elastomeric layer can have a thickness of about 50 μm to about 100 μm. The common substrate layer can have any suitable thickness, for example, in a range of about 50 μm to about 5 mm, about 50 μm to about 100 μm, or about 1 mm to about 5 mm. For example, the common substrate layer can have a minimum thickness of about 50, 100, 200, 300, 400, 500, 600, 700, 800, 900, 1000, 2000, 3000, 4000, or 5000 μm. For example, the common substrate layer can have a maximum thickness of about 50, 100, 200, 300, 400, 500, 600, 700, 800, 900, 1000, 2000, 3000, 4000, or 5000 μm. The thickness of the common substrate layer can be decreased as the rigidity of the polymer used to form the common substrate layer increases. For example, for a gel polymer (e.g., agarose), the common substrate layer can have a thickness in a range of about 1 mm to about 5 mm. For other, more rigid, polymers (e.g., PDMS) the common substrate layer can have a thickness in a range of about 50 μm to about 100 μm, for example. The tip array can be affixed or adhered to a rigid support (e.g., glass, such as a glass slide). In various cases, the common substrate, the tip array, and/or the rigid support, if present, is translucent or transparent. In a specific case, each is translucent or transparent. The combined thickness of the tip substrate layer and the tips can be in range of about 50 μm to about 5 mm. The thickness of combination of the tip array and common substrate can be less than about 200 μm, preferably less than about 150 μm, or more preferably about 100 μm.

The polymer backing layer is preferably adhered to a rigid support (e.g., a glass, silicon, quartz, ceramic, polymer, or any combination thereof), e.g., prior to or via curing of the polymer. The rigid support is preferably highly rigid and has a highly planar surface upon which to mount the array (e.g., silica glass, quartz, and the like). The rigid support and thin backing layer significantly improve the uniformity of the polymer pen array over large areas, such as a three inch wafer surface, and make possible the leveling and uniform, controlled use of the array.

The tip-to-tip spacing between adjacent tips (tip pitch) can be in any desired range, including a range of about 1 μm to about over 10 mm, or about 20 μm to about 1 mm. For example, the minimum tip-to-tip spacing can be about 1 μm, 2 μm, 3 μm, 4 μm, 5 μm, 6 μm, 7 μm, 8 μm, 9 μm, 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, 100 μm, 200 μm, 300 μm, 400 μm, 500 μm, 600 μm, 700 μm, 800 μm, 900 μm, 1 mm, 2 mm, 3 mm, 4 mm, 5 mm, 6 mm, 7 mm, 8 mm, 9 mm, or 10 mm. For example, the maximum tip-to-tip spacing can be about 1 μm, 2 μm, 3 μm, 4 μm, 5 μm, 6 μm, 7 μm, 8 μm, 9 μm, 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, 100 μm, 200 μm, 300 μm, 400 μm, 500 μm, 600 μm, 700 μm, 800 μm, 900 μm, 1 mm, 2 mm, 3 mm, 4 mm, 5 mm, 6 mm, 7 mm, 8 mm, 9 mm, or 10 mm.

Polymer pen arrays for use in Beam Pen Lithography generally include a pen array with each tip having a blocking layer disposed thereon, and with an aperture defined in the blocking layer, exposing the transparent tip end (e.g., the photosensitive layer-contacting end of each of the tips). The blocking layer can be coated on the sidewalls of the tips and on portions of the common substrate layer between the tips. The blocking layer serves as a radiation blocking layer, channeling the radiation through the material of the tip and out the exposed tip end. The tips can be used to both channel the radiation to a surface in a massively parallel scanning probe lithographic process and to control one or more parameters such as the distance between the tip and the substrate, and the degree of tip deformation. Control of such parameters can allow one to take advantage of near-field effects. In one embodiment, the tips are elastomeric and reversibly deformable, which can allow the tip array to be brought in contact with the substrate without damage to the substrate or the tip array. This contact can ensure the generation of near-field effects.

The blocking layer on the polymer tip sidewalls serves as a radiation blocking layer, allowing the radiation illuminated on a surface of the substrate layer opposite the surface to which the tips are fixed to be emitted only through the tip end exposed by the aperture defined in the blocking layer. The exposure of a substrate pre-coated with a resist layer with the radiation channeled through the tip ends of the tip array can allow for the formation of a single dot per tip for each exposure. The blocking layer can be formed of any material suitable for blocking (e.g., reflecting) a type of radiation used in the lithography process. For example, the blocking layer can be a metal, such as gold, when used with UV light. Other suitable blocking layers include, but are not limited to, gold, chromium, titanium, silver, copper, nickel, silicon, aluminum, opaque organic molecules and polymers, and combinations thereof. The blocking layer can have any suitable thickness, for example, in a range of about 40 nm to about 500 nm. For example, the minimum thickness can be about 40, 45, 50, 55, 60, 65, 70, 75, 80, 85, 90, 95, 100, 150, 200, 250, 300, 350, 400, 450, or 500 nm. For example, the maximum thickness can be about 40, 45, 50, 55, 60, 65, 70, 75, 80, 85, 90, 95, 100, 150, 200, 250, 300, 350, 400, 450, or 500 nm.

As with polymer pen arrays for Polymer Pen Lithography and Gel Pen Lithography, the tips of the pen array for use with BPL can be made by molding with a master prepared by conventional photolithography and subsequent wet chemical etching. Optionally, the tips can be cleaned, for example, using oxygen plasma, prior to coating with the blocking layer. The blocking layer can be disposed on the tips by any suitable process, including coating, for example, spin-coating, the tips with the blocking layer.

An aperture in the blocking layer can be formed by any suitable method, including, for example, focused ion beam (FIB) methods or using a lift-off method. The lift-off method can be a dry lift off method. One suitable approach includes applying an adhesive, such as poly(methyl methacrylate) (PMMA) on top of the blocking layer of the tip array, and removing a portion of the adhesive material disposed at the substrate contacting end of the tips by contacting the pen array to a clean and flat surface, for example, a glass surface. The tips can then be immersed in an etching solution to remove the exposed portion of the blocking layer to form the aperture and expose the material of the tip, e.g. the transparent polymer. The remaining adhesive material protects the covered surfaces of the blocking layer from being etched during the etching step. The adhesive can be, for example, PMMA, poly(ethylene glycol) (PEG), polyacrylonitrile, and combinations thereof.

Alternatively, a simple contact approach can be used in which a pen array having the blocking layer is brought in contact with a glass slide or other surface coated with an adhesive material, such as PMMA. Other suitable adhesive materials include, for example, PMMA, PEG, polyacrylonitrile, and combinations thereof. Upon removal of the pen tip from surface coated with the adhesive material, the adhesive material removes the contacted portion of the blocking layer, thereby defining an aperture and exposing the tip material, e.g. the transparent polymer.

In either of the above described aperture forming methods, the size of the aperture formed can be controlled by applying different external forces on the backside of the BPL pen array. As a result of the flexibility of elastomeric tips, the application of force on the backside of the BPL tip array can be used to control the contact area between the tips and adhesive material surface. For example, the BPL pen array can include pyramidal tips, with each pyramid-shaped tip being covered by a gold blocking layer having a small aperture defined in the blocking layer at the very end of the tip. The size of the aperture does not significantly change from tip to tip. For example, the size of the aperture can vary less than about 10% from tip to tip. The size of the aperture can be tailored over the 200 nm to 1 to 10 μm ranges, for example, by controlling contact force. For example, the aperture can have a diameter in a range of about 5 nm to about 5 μm, about 30 nm to about 500 nm, or about 200 nm to about 5 μm. For example, the minimum aperture diameter can be about 5, 10, 15, 20, 25, 30, 35, 40, 45, 50, 55, 60, 65, 70, 75, 80, 85, 90, 95, 100, 200, 300, 400, 500, 600, 700, 800, 900 1000, 1500, 2000, 2500, 3000, 3500, 4000, 4500, or 5000 nm. For example, the maximum aperture diameter can be about 5, 10, 15, 20, 25, 30, 35, 40, 45, 50, 55, 60, 65, 70, 75, 80, 85, 90, 95, 100, 200, 300, 400, 500, 600, 700, 800, 900 1000, 1500, 2000, 2500, 3000, 3500, 4000, 4500, or 5000 nm. The contact force optionally can be in a range of about 0.002 N to about 0.2 N for a 1 cm² pen array.

### Tilting of the Polymer Pen Array

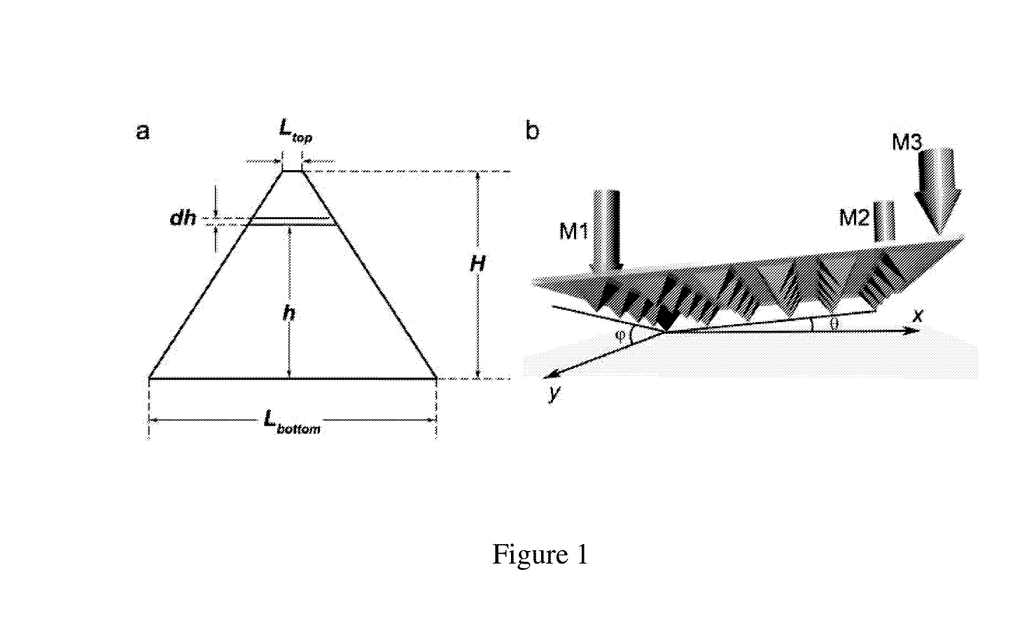

Uniform patterns having feature sizes that are substantially the same can be formed, as is known in the art, by contacting the substrate with a level polymer pen array. Combinatorial patterns can be formed by tilting the polymer pen array relative to the substrate surface. Assuming perfect leveling, the total force F exerted on a substrate surface by a polymer pen array (measured by a force sensor beneath the substrate) is related to the change in height of the polymer pen Z, as shown in Equation 1:

$$F ( Z ) = \frac{{NEL}_{bottom} {L}_{top}}{H} Z \qquad Equation 1$$

wherein N is the total number of pens in the array, E is the compression modulus of the elastomer used, H is the total height of the pyramidal tip prior to compression, L_{bottom} is the edge length at the bottom surface of the pyramidal tip, and Lₜₒₚ is the edge length at the top surface of the pyramidal tip. See Liao et al., 10 Nano Lett. 1335-40 (2010). Under perfect leveling, the change in height Z is equal to the z-piezo extension Z₀. FIG. 1a is a schematic drawing of the pyramidal tip illustrating the dimensions of the tip. The pyramidal tip can be formed, for example, of poly-(dimethylsiloxane) (PDMS).

The compression modulus E of PDMS, for example, depends on the compression ratio, which is described by the Mooney-Rivlin equation. For example, a two stage model of the compression modulus can be employed such that there exists a threshold value of the z-piezo extension zₜ, below which E=E₁ and above which E=E₂. For example, for PDMS, E₁ can equal 1.38 MPa and E₂ can equal 8.97 MPa. Thus, the force can be determined by Equations 2 and 3 for different values of Z.

$$\begin{matrix}F = {NE}_{1} {L}_{bottom} {L}_{top} \frac{Z}{H} , \\ when Z \leq {z}_{t} & Equation 2 \\ F = {NE}_{1} {L}_{bottom} {L}_{top} \frac{{z}_{t}}{H} + {NE}_{2} {L}_{bottom} {L}_{top} \frac{Z - {z}_{t}}{H} , \\ when Z > {z}_{t} & Equation 3\end{matrix}$$

Referring to FIG. 1b, the tilting between the array and the substrate surface can be described by two angles θ and φ, which are related to the x- and y-axes between the plane of the pen array and the plane of the substrate surface. For a pen array having a regular periodic pattern of tips, for example, the x- and y-axes can be disposed parallel to the rows and columns of tips in the regular periodic pattern, respectively. To bring the pen array in contact with or near to the substrate surface, the array and substrate are brought together in the z-axis direction, perpendicular to the x- and y-axes. Likewise, to compress pens against the surface, the surface and pen array are brought together in the z-axis direction, with increased force applied after initial contact. Under z-piezo extension, the compression of each pen varies with θ and φ, the z-piezo extension, and the distance of the particular pen from the closet pen to the surface Nₓ and N_{y}, along the x- and y-axes, respectively. If the compression of the first pen to contact the surface is Z₀, the Zₚₑₙ for any single pen in the array can be calculated using Equation 4:

Zₚₑₙ(Nₓ,N_{y},θ,φ)=Z₀−DNₓ sin(θ−DN_{y} sin(φ) Equation 4

wherein D is the spacing between pens in the pen array, and Nₓ and N_{y} are the number of pens from the first pen to contact the surface along the x and y axes, respectively.

The force generated by any single pen on the surface can be calculated as a function of Z, θ, φ, Nₓ, and N_{y} using Equation 5 or 6, depending on the value of Z:

$$\begin{matrix}F ( {N}_{x} , {N}_{y} , θ , ϕ ) = \frac{{E}_{1} {L}_{bottom} {L}_{top}}{H} ( {Z}_{0} - {DN}_{x} sin ( θ ) - {DN}_{y} sin ( ϕ ) ) , \\ when Z \leq {z}_{t} & Equation 5 \\ F ( {N}_{x} , {N}_{y} , θ , ϕ ) = \frac{{E}_{1} {L}_{bottom} {L}_{top}}{H} {Z}_{t} + \frac{{E}_{2} {L}_{bottom} {L}_{top}}{H} ( {Z}_{0} - {z}_{t} - {DN}_{x} sin ( θ ) - {DN}_{y} sin ( ϕ ) ) , \\ when Z > {z}_{t} & Equation 6\end{matrix}$$

Referring to FIG. 2a, using the above basic model, the relationship between total force and the tilt of the array can be calculated. FIG. 2b illustrates the calculated maximum and minimum feature size as a function of the tilting angles (θ and φ). FIGS. 2a and 2b demonstrate the sensitive dependence of feature size on the tilt between the array and the substrate surface.

The total force can be calculated using Equation 7:

$${F}_{total} ( θ , ϕ ) = {\sum }_{{N}_{x}}^{ } {\sum }_{{N}_{y}}^{ } F ( {N}_{x} , {N}_{y} , θ , ϕ ) \qquad Equation 7$$

Because Fₜₒₜₐₗ is a function of θ and φ, when these angles are changed, Fₜₒₜₐₗ between the pen array and the surface also changes for the same z-piezo extension (Z₀). From this relationship it can be concluded that at the perfect leveling position, (θ, φ)=(0, 0), the total force between the tip array and the surface reaches a global maximum. For any given value of θ, Fₜₒₜₐₗ reaches a local maximum value when φ=0, and vice versa. As θ and φ approach 0, the gradient in force with respect to changes in the angle, ∂F/∂θ and ∂F/∂φ, increases and is not a function of Z₀ as shown in Equations 8 and 9:

$$\begin{matrix}\frac{\partial {F}_{total}}{\partial θ} = {\sum }_{{N}_{x}}^{ } {\sum }_{{N}_{y}}^{ } \frac{\partial F}{\partial θ} = - {\sum }_{{N}_{x}}^{ } {\sum }_{{N}_{y}}^{ } \frac{{E}_{1} {L}_{bottom} {L}_{top}}{H} {DN}_{x} cos ( θ ) , \\ when Z \leq {z}_{t} \\ \frac{\partial {F}_{total}}{\partial θ} = {\sum }_{{N}_{x}}^{ } {\sum }_{{N}_{y}}^{ } \frac{\partial F}{\partial θ} = - {\sum }_{{N}_{x}}^{ } {\sum }_{{N}_{y}}^{ } \frac{{E}_{2} {L}_{bottom} {L}_{top}}{H} {DN}_{x} cos ( θ ) , \\ when Z > {z}_{t} & Equation 8 \\ \frac{\partial {F}_{total}}{\partial ϕ} = {\sum }_{{N}_{x}}^{ } {\sum }_{{N}_{y}}^{ } \frac{\partial F}{\partial ϕ} = - {\sum }_{{N}_{x}}^{ } {\sum }_{{N}_{y}}^{ } \frac{{E}_{1} {L}_{bottom} {L}_{top}}{H} {DN}_{y} cos ( ϕ ) , \\ when Z \leq {z}_{t} \\ \frac{\partial {F}_{total}}{\partial ϕ} = {\sum }_{{N}_{x}}^{ } {\sum }_{{N}_{y}}^{ } \frac{\partial F}{\partial ϕ} = - {\sum }_{{N}_{x}}^{ } {\sum }_{{N}_{y}}^{ } \frac{{E}_{2} {L}_{bottom} {L}_{top}}{H} {DN}_{y} cos ( ϕ ) , \\ when Z > {z}_{t} & Equation 9\end{matrix}$$

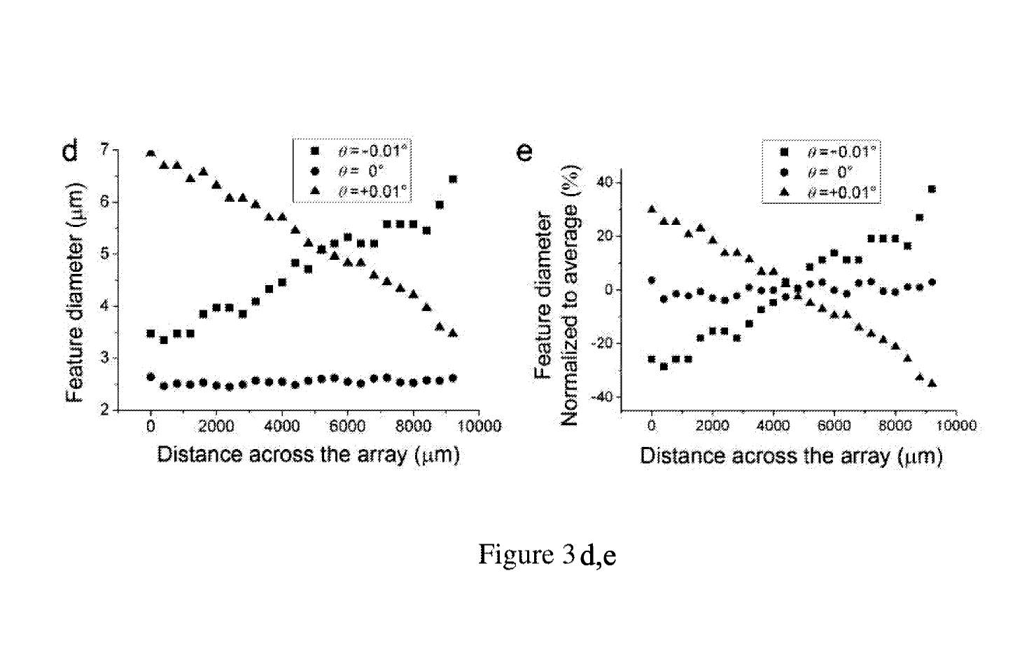

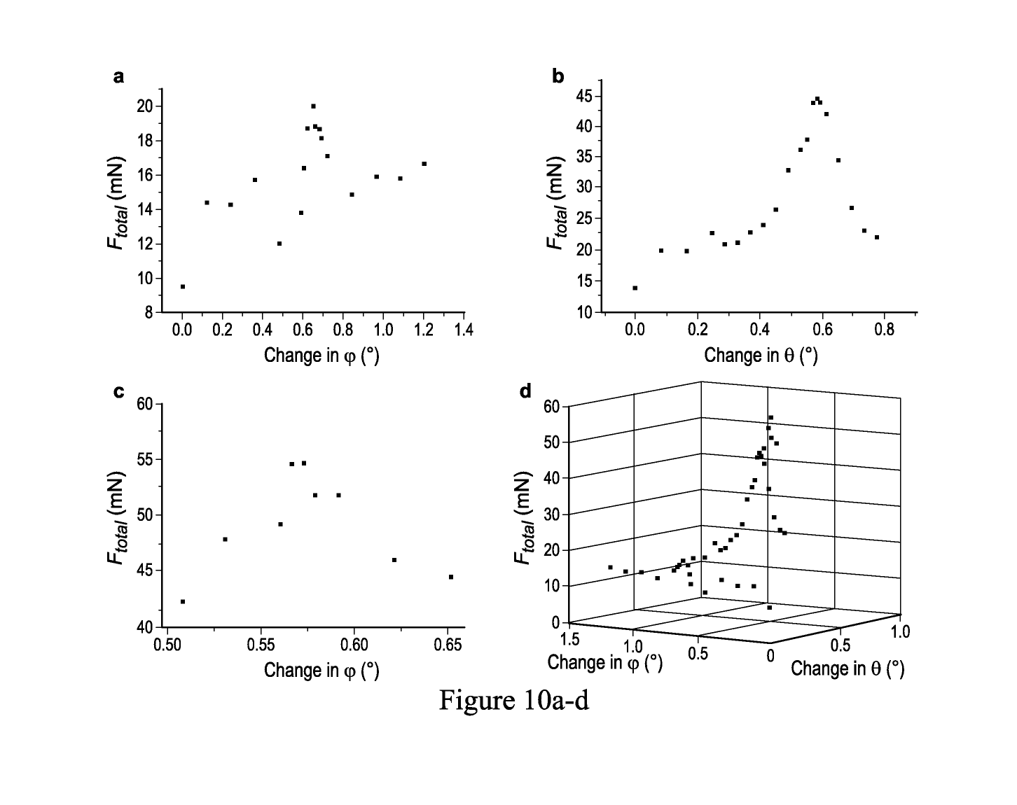

Based on this model, an iterative process for attaining perfect leveling between the two planes was devised. Such a leveling method can achieve leveling of the pen array within at least about 0.004°, and more preferably within at least about 1.6×10⁻⁴ degrees when using a force sensor having a sensitivity of about 0.1 mN. It may be possible to achieve more accurate leveling with a force sensor having increased sensitivity. Leveling is accomplished by first contacting a surface with the pen array and measuring a force exerted on the surface by the pen array. The force can be measured in any suitable way. For example, the force can be measured by placing a force sensor beneath the surface. Alternatively, the force sensor can be the contacted surface. The pen array and/or the surface is then tilted to vary one of the angles, e.g., θ, by a tilt angle increment while keeping the other angle, φ, constant, and the total force exerted by the pen array on the surface is again measured. This process is repeated until a local maximum of the total force is found. The position of the pen array once the local maximum of the total force is measured is the optimized position for θ. Referring to FIG. 10a, the measured values of the total force can be plotted as a function of the change in θ to determine when a local maximum of the total force has been measured. The pen array and/or the surface is next tilted to vary the other one of the angles, φ, by a tilt angle increment while holding θ at the previously determined optimized position and measuring the total force exerted by the pen array on the surface. This process is repeated until a local maximum of the total force is measured. The position of the pen array once the local maximum of the total force is measured is the optimized position for φ. Referring to FIG. 10b, the measured values of the force can be plotted as a function of the change in φ to determine when a local maximum of the total force has been measured. The tilt of the pen is then finely varied to vary the optimized position of the first varied angle, θ, while holding φ at the previously determined optimized position until a global maximum of the total force exerted by the pen array is found. Referring to FIG. 10c, the measured values of the total force can be plotted as a function of the change in θ to determine when a global maximum of the total force has been measured. FIG. 10d illustrates a three-dimensional plot generated from FIGS. 10a-10c illustrating the above-described leveling method. This routine, or suitable equivalent, can be incorporated into a software algorithm to receive force values and control an automated stage for computer-controlled leveling of a pen array. The features produced after leveling by this force feedback strategy vary only by about 2% across the 1 cm of writing surface with the 15,000 pen array. FIGS. 3a-3c illustrate the patterns made by a 10,000 pen array with (a) θ=0°, (b) θ=0.01°, and (c) θ=−0.01°. FIG. 3d illustrates the relationship between the feature size and distance along the pen array as a function of the different leveling conditions. FIG. 3e illustrates the diameters of different feature sizes for different leveling conditions, normalized to the θ=0° leveling condition.

In the above-described leveling method, the tilt angle increment for varying either or both of θ and φ can be in a range of about 1.6×10⁻⁴ degrees to about 0.1°, about 0.0005° to about 0.05°, about 0.005° to about 0.01°, or about 0.001° to about 0.05°. For example, the minimum tilt angle increment can be about 0.00016, 0.0002, 0.0003, 0.0004, 0.0005, 0.0006, 0.0007, 0.0008, 0.0009, 0.001, 0.002, 0.003, 0.004, 0.005, 0.006, 0.007, 0.008, 0.009, 0.01, 0.02, 0.03, 0.04, 0.05, 0.06, 0.07, 0.08, 0.09, and 0.1°. For example, the maximum tilt angle increment can be about 0.00016, 0.0002, 0.0003, 0.0004, 0.0005, 0.0006, 0.0007, 0.0008, 0.0009, 0.001, 0.002, 0.003, 0.004, 0.005, 0.006, 0.007, 0.008, 0.009, 0.01, 0.02, 0.03, 0.04, 0.05, 0.06, 0.07, 0.08, 0.09, and 0.1°.

The angles of the pen array can be adjusted by tilting one or both of the pen array and the surface. For example, the pen array alone can be tilted, the surface alone can be tilted, or both the pen array and the surface can be tilted. For example, the tilting of the pen array can be achieved by providing a motor-controlled, multi-axis stage attached to the pen array, and controlling the degree of extension of one or more motors to induce the desired tilt angles. For example, referring to FIG. 1b, three motors M1, M2, and M3, can hold the pen array. When the two motors M1 and M3 are fixed and the motor M2 is adjusted, the pen array will be tilted in the φ-direction. For example, when the two motors M1 and M3 are fixed and the motor M2 is increased by 100 μm, φ will increase by about 0.08°. When the two motors M2 and M3 are fixed and the motor M1 is increased by 100 μm, θ will increase about 0.04°. Any other method of adjusting the pen array and/or the surface relative to the pen array can be used. Tilting can also be achieved, for example, by holding the pen array in the level position and tilting the substrate surface relative to the pen array.

By utilizing the model developed for force feedback leveling of the pen array, the pen array can be intentionally and precisely tilted with respect to the perfect leveling position to create a combinatorial array of features across a surface. Such a combinatorial array of features can be printed in a single printing operation. For example, by first leveling the pen array and then by controllably varying the tilt angles, e.g., θ and φ, the size of each feature printed by the pens of the pen array will vary controllably and predictably, with the dimensions of each feature being spatially encoded. The pen array can be leveled, for example, using force feedback leveling or other optical leveling means.

Using Equation 7, the size of each feature made by a given pen can be calculated. The degree of tilt and step size for varying tilt are not limitations of the invention in principle, and may vary with the particular apparatus used to carry out the invention. For example, θ can be varied in a range of about −20° to about 20°, about −15° to about 15°, about −10° to about 10°, about −5° to about 5°, about −6° to about 6°, about −0.1° to about 0.10, about −0.05° to about 0.050, about −0.01° to about 0.01°, about −0.001° to about 0.001°, and about −0.0001° to about 0.0001°. For example, θ can have a minimum value of about −20, −18, −16, −14, −12, −10, −8, −6, −4, −2, −1, −0.5, −0.1, −0.05, −0.01, −0.001, −0.0001, 0, 0.0001, 0.001, 0.01, 0.05, 0.1, 0.5, 1, 2, 4, 6, 8, 10, 12, 14, 16, 18, or 20°. For example, θ can have a maximum value of about −20, −18, −16, −14, −12, −10, −8, −6, −4, −2, −1, −0.5, −0.1, −0.05, −0.01, −0.001, 0.0001, 0, 0.0001, 0.001, 0.01, 0.05, 0.1, 0.5, 1, 2, 4, 6, 8, 10, 12, 14, 16, 18, or 20°. For example, φ can be varied in a range of −20° to about 20°, about −15° to about 15°, about −10° to about 10°, about −6° to about 6°, about −5° to about 5°, about −0.01° to about 0.1°, about −0.05° to about 0.05°, about −0.01° to about 0.01°, about −0.001° to about 0.001°, and about −0.0001° to about 0.0001°. For example, φ can have a minimum value of about −20, −18, −16, −14, −12, −10, −8, −6, −4, −2, −1, −0.5, −0.1, −0.05, −0.01, −0.001, −0.0001, 0, 0.0001, 0.001, 0.01, 0.05, 0.1, 0.5, 1, 2, 4, 6, 8, 10, 12, 14, 16, 18, or 20°. For example, φ can have a maximum value of about −20, −18, −16, −14, −12, −10, −8, −6, −4, −2, −1, −0.5, −0.1, −0.05, −0.01, −0.001, −0.0001, 0, 0.0001, 0.001, 0.01, 0.05, 0.1, 0.5, 1, 2, 4, 6, 8, 10, 12, 14, 16, 18, or 20°. For larger tilt angles, for example, angles having a magnitude larger than 6°, it may be necessary to use an object such as a wedge placed beneath the substrate or a substrate stage of a polymer pen machine to assist in achieving the larger tilt angle. One or both of the tilt angles, θ and φ can be varied to generate a combinatorial array of features across the surface. For example, in one embodiment one of the tilt angles can be held at 0°, while the other tilt angle is chosen to be a non-zero value. When both tilt angles are chosen to be non-zero values, the tilt angles can be chosen to have the same or different degrees of tilt. The tilt angles can also be chosen to have the same or different sign. For example, the tilt angle θ can be chosen to be a positive angle, while the tilt angle φ can be chosen to be a negative angle. The tilt angles can be chosen to have different magnitudes. For example, the tilt angle θ can be chosen to be 0.1° and the tilt angle φ can be chosen to be 0.5°. The tilt angles can be controllably varied within 1×10⁻⁴ degrees, for example.

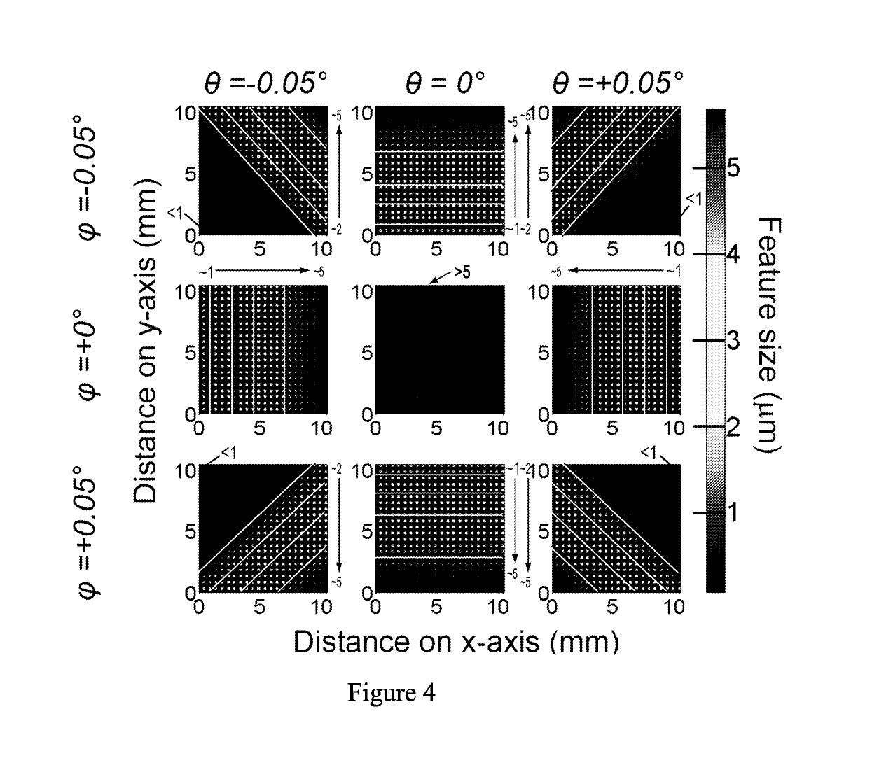

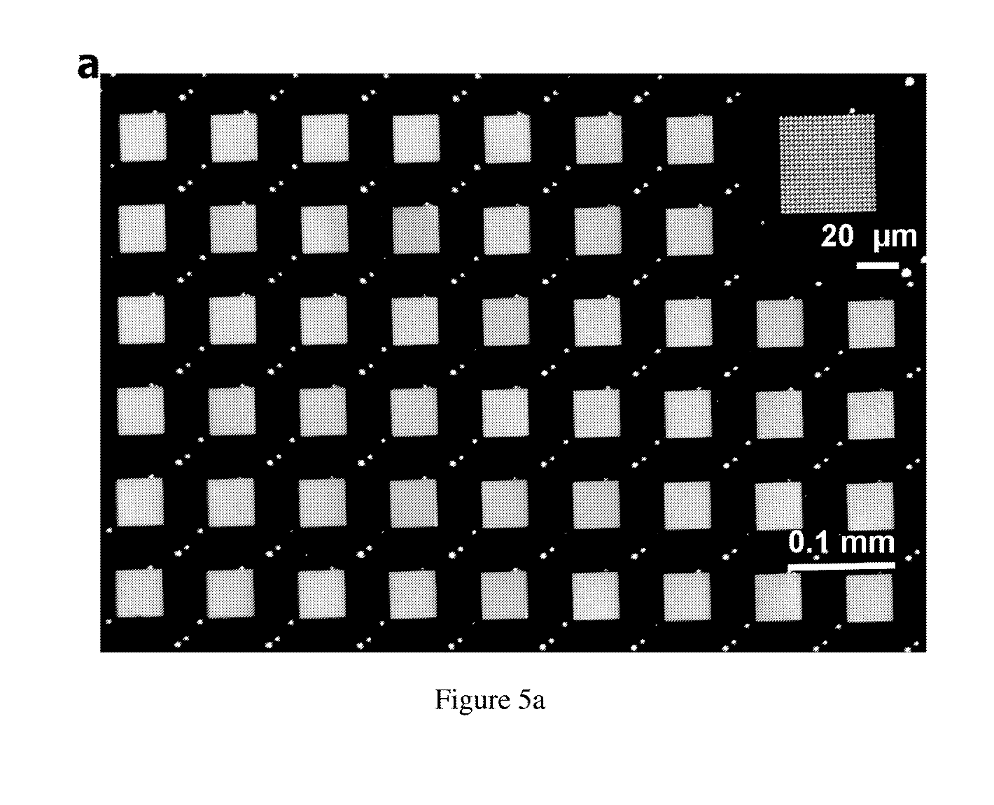

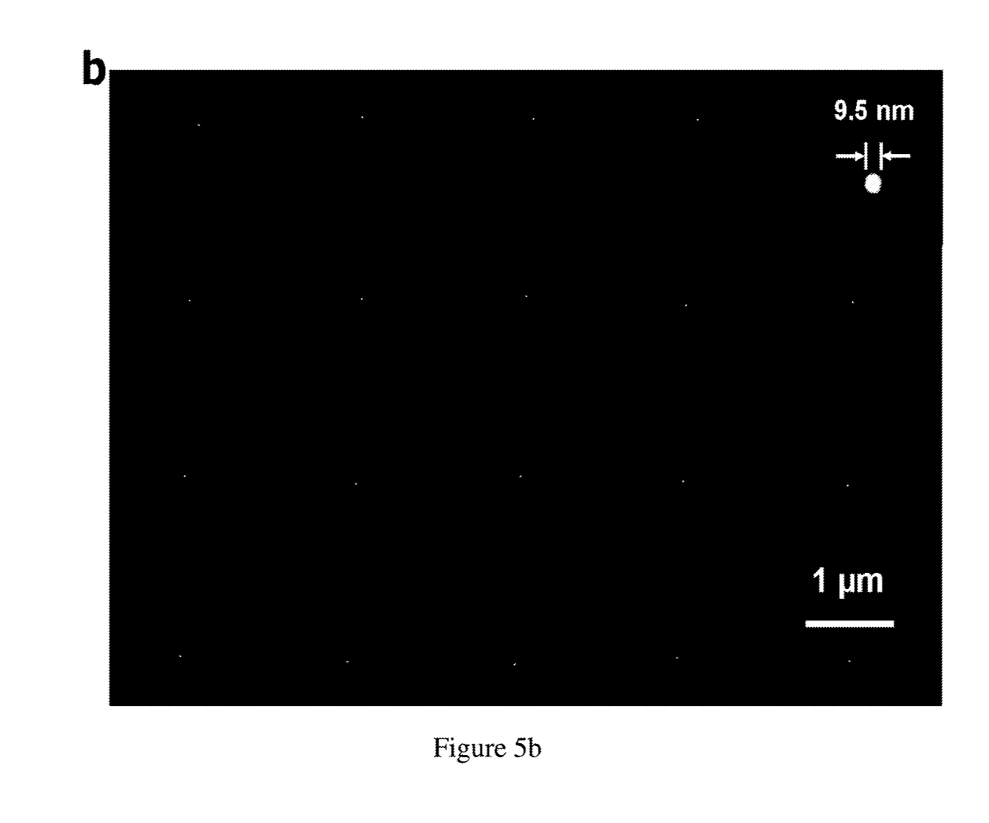

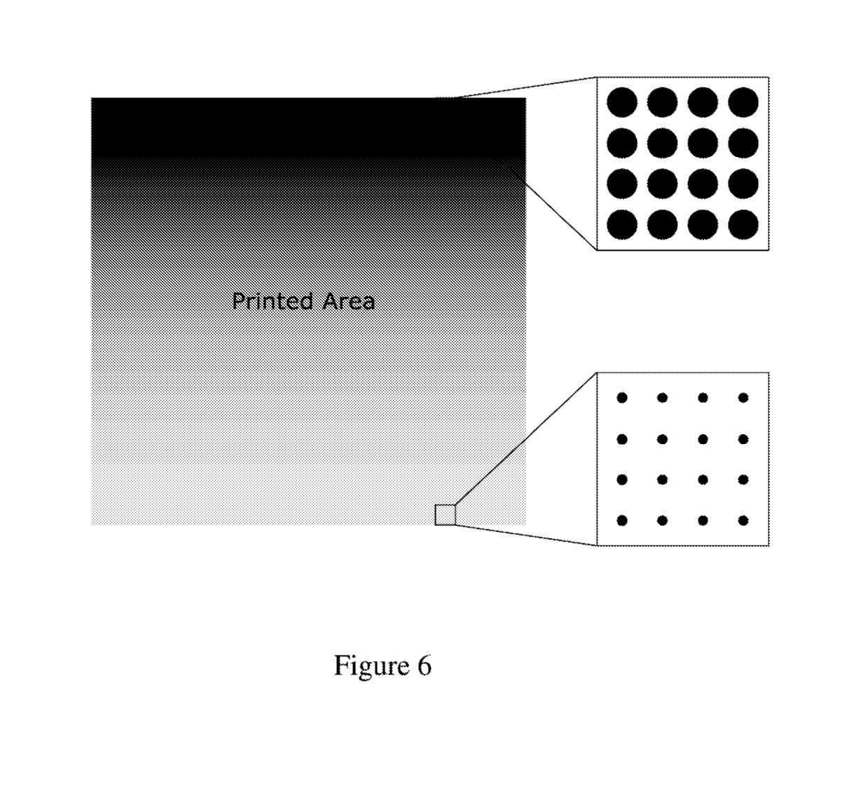

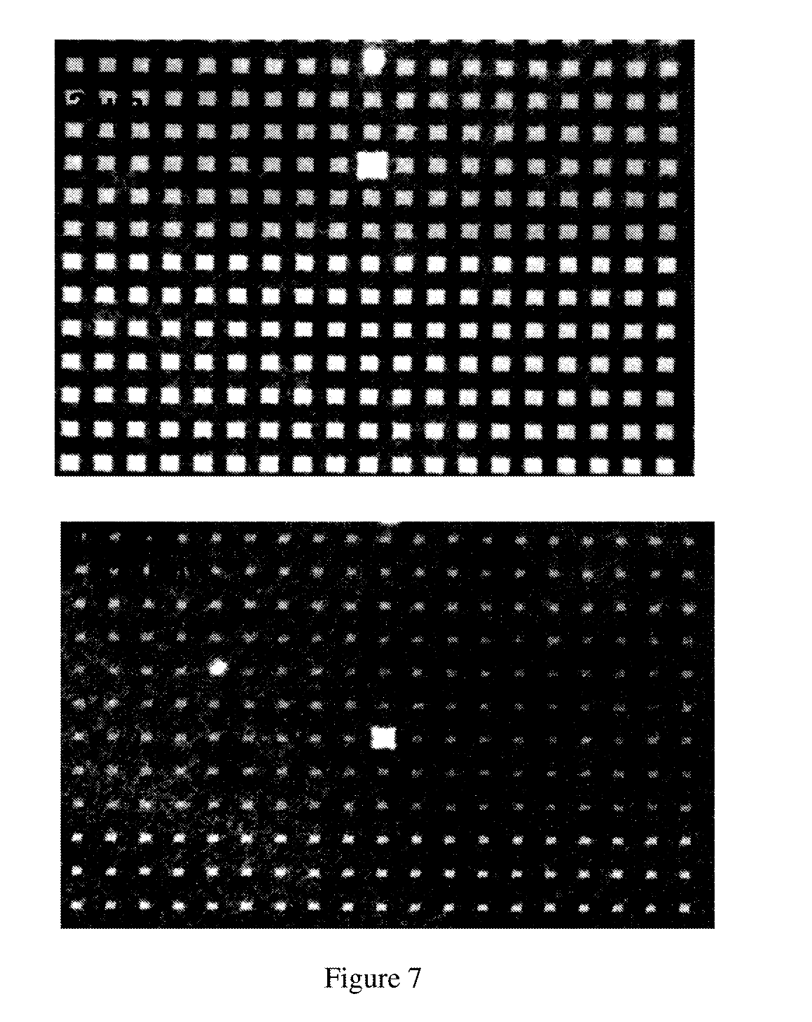

As shown in FIG. 4, by intentionally tilting the array, patterns with a gradient of feature sizes can be created. Feature sizes vary in one axis, while remaining constant along the other axis. Thus, an array can be created where, for example, each row contains patterns of the same feature size, and the feature size decreases down a column. The redundancy of the feature size across a row can allow for statistically significant numbers to be obtained for each feature size. As illustrated in FIG. 6, patterns formed by deliberately tilting the pen array relative to the substrate include variation in feature size, while the pitch remains constant throughout the substrate. The spacing (i.e., the pitch) between adjacent elements of the pattern or printed indicia can be substantially equal to the tip-to-tip spacing of adjacent tips of the pen array.

Referring again to FIG. 2b, feature sizes across the combinatorial array can range from tens of nanometers to micron sized features. The difference in feature size across the combinatorial array can range from about 5 nm to about 100 μm, about 10 nm to about 100 μm. For example, the difference in feature size can be at a minimum about 5 nm, 10 nm, 20 nm, 40 nm, 50 nm, 100 nm, 150 nm, 200 nm, 250 nm, 300 nm, 350 nm, 400 nm, 450 nm, 500 nm, 550 nm, 600 nm, 650 nm, 700 nm, 750 nm, 800 nm, 850 nm, 900 nm 950 nm, 1 μm, 2 μm, 3 μm, 4 μm, 5 μm, 6 μm, 7 μm, 8 μm, 9 μm, 10 μm, 11 μm, 12 μm, 13 μm, 14 μm, 15 μm, 20 μm, 30 μm, 40 μm, 50 μm, 60 μm, 70 μm, 80 μm, 90 μm, or 100 μm. For example, the difference in feature size can be at a maximum about 5 nm, 10 nm, 20 nm, 40 nm, 50 nm, 100 nm, 150 nm, 200 nm, 250 nm, 300 nm, 350 nm, 400 nm, 450 nm, 500 nm, 550 nm, 600 nm, 650 nm, 700 nm, 750 nm, 800 nm, 850 nm, 900 nm 950 nm, 1 μm, 2 μm, 3 μm, 4 μm, 5 μm, 6 μm, 7 μm, 8 μm, 9 μm, 10 μm, 11 μm, 12 μm, 13 μm, 14 μm, 15 μm, 20 μm, 30 μm, 40 μm, 50 μm, 60 μm, 70 μm, 80 μm, 90 μm, or 100 μm. For example, the difference in size between adjacent features can be about 5 nm.

The substrate surface can be contacted with a pen array a plurality of times, wherein the pen array, the substrate surface or both move laterally with respect to one another to allow for different portions of the substrate surface to be contacted. The time and pressure of each contacting step can be the same or different, depending upon the desired pattern. Increased pressure can be applied by applying a force in the z-axis direction, perpendicular to the x- and y-axes of the substrate. For example, increasing the time and/or pressure of the contacting step can produce pattern elements having larger feature sizes. Additionally, the tilt geometry (tilt angles with respect to a substrate surface) of the pen array for each contacting step can be the same or different. When patterning using beam pen lithography, patterning can also be achieved when one or more pens are disposed in a non-contact mode, by irradiating the substrate surface with the radiation transmitted through the apertures in the tip(s) while the tip(s) of the array are in close proximity to the substrate surface. The pen array, the substrate surface, or both can be moved laterally with respect to one another to allow for different portions of the substrate surface to be irradiated. The irradiation time for each irradiating step can be the same or different to produce features having the same or different sizes.

### Force Dependent Feature Size

A defining characteristic of polymer pen lithography methods, in contrast with DPN and most contact printing strategies, which are typically viewed as pressure or force-independent, is that polymer pen lithography methods exhibit both time- and pressure-dependent ink transport.

The force dependence of the feature size when printing with polymer pen lithography methods can be predicted using the above-described force model. Specifically, the edge length of the printed feature L_{feature} can be estimated using Equation 10.

$${L}_{feature} = {L}_{top} + \frac{v}{{NEL}_{top}} F \qquad Equation 10$$

wherein Lₜₒₚ is the edge length at the top surface of the pyramidal tip, v is Poisson's ratio of the elastomer used to form the pens, N is the total number of pens in the pen array, E is the compression modulus of the elastomer used to form the pens, and F is the force generated by the pen array on the surface. Increased force can be generated by applying a pressure on the pen array in the z-axis direction, perpendicular to the x- and y-axes of the substrate. For example, the Poisson's ratio can be in a range of about 0.3 to about 0.5, about 0.4 to about 0.5, or about 0.3 to about 0.4. Other suitable values of Poisson's ratio include, for example, about 0.3, 0.31, 0.32, 0.33, 0.34, 0.35, 0.36, 0.37, 0.38, 0.39, 0.4, 0.41, 0.42, 0.43, 0.44, 0.45, 0.46, 0.47, 0.48, 0.49, and 0.5. For example, when PDMS is used as the elastomeric polymer, the Poisson's ratio is about 0.3.

As described above, a two stage model of the compression modulus can be employed such that there exists a threshold value of the z-piezo extension zₜ, below which, E=E₁=1.38 MPa and above which E=E₂=8.97 MPa. Thus, the edge length of the printed feature can be determined by Equations 11 and 12 for different values of Z.

$${L}_{feature} = {L}_{top} + \frac{v}{{NE}_{1} {L}_{top}} F , \\ when Z \leq {z}_{t} \qquad Equation 11$$

### Patterning Compositions

For polymer pen lithography methods utilizing a patterning composition, the pen array can be coated with a patterning composition, for example, by immersing the pen array in a patterning solution. The patterning composition can be, for example, adsorbed or absorbed onto to the pens of the pen array. Patterning compositions suitable for use in the disclosed methods include both homogeneous and heterogeneous compositions, the latter referring to a composition having more than one component. The patterning composition is coated on the tip array. The term “coating,” as used herein, refers both to coating of the tip array as well adsorption and absorption by the tip array of the patterning composition. Upon coating of the tip array with the patterning composition, the patterning composition can be patterned on a substrate surface by contacting the coated tip array with the substrate surface to deposit the patterning composition onto the substrate surface. For a description of suitable patterning compositions for use with Polymer Pen Lithography see, for example, International Patent Publication No. WO 2009/132321, the entire disclosure of which is incorporated herein by reference. For a description of suitable patterning compositions for use with Gel Pen Lithography see, for example, International Patent Application No. PCT/US2010/024631, the entire disclosure of which is incorporated herein by reference.

Patterning compositions can be liquids, solids, semi-solids, and the like. Patterning compositions suitable for use include, but are not limited to, molecular solutions, polymer solutions, pastes, gels, creams, glues, resins, epoxies, adhesives, metal films, particulates, solders, etchants, and combinations thereof. When using gel polymer pen arrays, wet inks can be directly patterned on a substrate surface. Wet inks include inks in the liquid state, including, for example, salt solutions, proteins in buffer, and etchants. The gel polymer pen array can also be used to pattern a patterning composition without the need to include patterning composition carriers in the patterning composition. For example, the patterning composition can be a biomaterial (e.g., albumin) free of exogenous carriers. Such ink carriers are known in the art, and include phospholipids, PEG, hydrogel PEG-DMA, and agarose, for example.

Patterning compositions can include materials such as, but not limited to, monolayer-forming species, thin film-forming species, oils, colloids, metals, pre-formed metal nanoparticles, metal nanoparticle precursors, metal complexes, metal oxides, ceramics, organic species (e.g., moieties comprising a carbon-carbon bond, such as small molecules, polymers, polymer precursors, proteins, antibodies, and the like), polymers (e.g., both non-biological polymers and biological polymers such as single and double stranded DNA, RNA, and the like), polymer precursors, dendrimers, nanoparticles, and combinations thereof. In some embodiments, one or more components of a patterning composition includes a functional group suitable for associating with a substrate, for example, by forming a chemical bond, by an ionic interaction, by a Van der Waals interaction, by an electrostatic interaction, by magnetism, by adhesion, and combinations thereof.

In some embodiments, one or more components of the patterning compositions includes a functional group suitable for associating with an analyte and/or an analyte interacting element. For example, the patterning composition can include an alkanethiol. The alkanethiol can include a functional group selected from the group consisting of a carboxylic acid, a phosphate, a sulfur, or nitrogen. For example, the pattern composition can include 16-mercaptohexadecanoic acid (MHA). The alkanethiol can be a poly- or oligoethylene glycol thiol, such as, for example, 11-mercaptoundecyl-penta(ethylene glycol). While exemplified herein is the use of pattern element comprising an alkanethiol substituted with a carboxylic acid functional group, a person of ordinary skill will appreciate that this class of compound can be substituted with any of a number of other compounds with the same or similar functional groups that provide the same or similar surface and metal ion interactions. In certain instances, the choice of compound depends on the type of surface and/or substrate. For example, when using a glass surface, use of a siloxane is contemplated. In methods using a substituted alkanethiol, the alkanethiols used are linear and branched alkanethiols having a carbon chain length of from C₈ to C₂₂. Linear alkanethiols have, in certain aspects, a chain length of C₈, C₉, C₁₀, C₁₁, C₁₂, C₁₃, C₁₄, C₁₅, C₁₆, C₁₇, C₁₈, C₁₉, C₂₀, C₂₁ or C₂₂. Alkanethiols which may be mentioned are carboxylic acid terminated forms of n-decanethiol, n-dodecanethiol, tert-dodecanethiol, n-tetradecanethiol, n-pentadecanethiol, n-hexadecanethiol, n-heptadecanethiol, n-octadecanethiol, n-nonadecanethiol, n-eicosanethiol, n-docosanethiol. Methyl-terminated alkanethiols, such as octadecanethiol and analogs thereof can also be used. Proteins can be adsorbed onto methyl-terminated alkanethiols through hydrophobic interactions.

In various embodiments, the patterning composition can include as a component an analyte interacting element. Suitable analyte interacting elements are described in detail below. In other embodiments, the analyte interacting element can be attached, immobilized on, or otherwise disposed on the pattern element after the pattern is formed.

In some embodiments, the composition can be formulated to control its viscosity. Parameters that can control ink viscosity include, but are not limited to, solvent composition, solvent concentration, thickener composition, thickener concentration, particles size of a component, the molecular weight of a polymeric component, the degree of cross-linking of a polymeric component, the free volume (i.e., porosity) of a component, the swellability of a component, ionic interactions between ink components (e.g., solvent-thickener interactions), and combinations thereof.

In some embodiments, the patterning composition comprises an additive, such as a solvent, a thickening agent, an ionic species (e.g., a cation, an anion, a zwitterion, etc.) the concentration of which can be selected to adjust one or more of the viscosity, the dielectric constant, the conductivity, the tonicity, the density, and the like.

Suitable thickening agents include, but are not limited to, metal salts of carboxyalkylcellulose derivatives (e.g., sodium carboxymethylcellulose), alkylcellulose derivatives (e.g., methylcellulose and ethylcellulose), partially oxidized alkylcellulose derivatives (e.g., hydroxyethylcellulose, hydroxypropylcellulose and hydroxypropylmethylcellulose), starches, polyacrylamide gels, homopolymers of poly-N-vinylpyrrolidone, poly(alkyl ethers) (e.g., polyethylene oxide, polyethylene glycol, and polypropylene oxide), agar, agarose, xanthan gums, gelatin, dendrimers, colloidal silicon dioxide, lipids (e.g., fats, oils, steroids, waxes, glycerides of fatty acids, such as oleic, linoleic, linolenic, and arachidonic acid, and lipid bilayers such as from phosphocholine) and combinations thereof. In some embodiments, a thickener is present in a concentration of about 0.5% to about 25%, about 1% to about 20%, or about 5% to about 15% by weight of a patterning composition.

Suitable solvents for a patterning composition include, but are not limited to, water, C1-C8 alcohols (e.g., methanol, ethanol, propanol and butanol), C6-C12 straight chain, branched and cyclic hydrocarbons (e.g., hexane and cyclohexane), C6-C14 aryl and aralkyl hydrocarbons (e.g., benzene and toluene), C3-C10 alkyl ketones (e.g., acetone), C3-C10 esters (e.g., ethyl acetate), C4-C10 alkyl ethers, and combinations thereof. In some embodiments, a solvent is present in a concentration of about 1% to about 99%, about 5% to about 95%, about 10% to about 90%, about 15% to about 95%, about 25% to about 95%, about 50% to about 95%, or about 75% to about 95% by weight of a patterning composition.

Patterning compositions can comprise an etchant. As used herein, an “etchant” refers to a component that can react with a surface to remove a portion of the surface. Thus, an etchant is used to form a subtractive feature by reacting with a surface and forming at least one of a volatile and/or soluble material that can be removed from the substrate, or a residue, particulate, or fragment that can be removed from the substrate by, for example, a rinsing or cleaning method. In some embodiments, an etchant is present in a concentration of about 0.5% to about 95%, about 1% to about 90%, about 2% to about 85%, about 0.5% to about 10%, or about 1% to about 10% by weight of the patterning composition.

Etchants suitable for use in the methods disclosed herein include, but are not limited to, an acidic etchant, a basic etchant, a fluoride-based etchant, and combinations thereof. Acidic etchants suitable for use include, but are not limited to, sulfuric acid, trifluoromethanesulfonic acid, fluorosulfonic acid, trifluoroacetic acid, hydrofluoric acid, hydrochloric acid, carborane acid, and combinations thereof. Basic etchants suitable for use include, but are not limited to, sodium hydroxide, potassium hydroxide, ammonium hydroxide, tetraalkylammonium hydroxide ammonia, ethanolamine, ethylenediamine, and combinations thereof. Fluoride-based etchants suitable for use include, but are not limited to, ammonium fluoride, lithium fluoride, sodium fluoride, potassium fluoride, rubidium fluoride, cesium fluoride, francium fluoride, antimony fluoride, calcium fluoride, ammonium tetrafluoroborate, potassium tetrafluoroborate, and combinations thereof. A hole array can be fabricated through directly etching a gold thin film with a commercial gold etchant using a gel polymer pen array. The diameter of the holes increases with increased contact time and/or applied force between the pen array and the substrate.

In some embodiments, the patterning composition includes a reactive component. As used herein, a “reactive component” refers to a compound or species that has a chemical interaction with a substrate. In some embodiments, a reactive component in the ink penetrates or diffuses into the substrate. In some embodiments, a reactive component transforms, binds, or promotes binding to exposed functional groups on the surface of the substrate. Reactive components can include, but are not limited to, ions, free radicals, metals, acids, bases, metal salts, organic reagents, and combinations thereof. Reactive components further include, without limitation, monolayer-forming species such as thiols, hydroxides, amines, silanols, siloxanes, and the like, and other monolayer-forming species known to a person of ordinary skill in the art. The reactive component can also include, for example, photo-activated species. The reactive component can be present in a concentration of about 0.001% to about 100%, about 0.001% to about 50%, about 0.001% to about 25%, about 0.001% to about 10%, about 0.001% to about 5%, about 0.001% to about 2%, about 0.001% to about 1%, about 0.001% to about 0.5%, about 0.001% to about 0.05%, about 0.01% to about 10%, about 0.01% to about 5%, about 0.01% to about 2%, about 0.01% to about 1%, about 10% to about 100%, about 50% to about 99%, about 70% to about 95%, about 80% to about 99%, about 0.001%, about 0.005%, about 0.01%, about 0.1%, about 0.5%, about 1%, about 2%, or about 5% weight of the patterning composition.

The patterning composition can further comprise a conductive and/or semi-conductive component. As used herein, a “conductive component” refers to a compound or species that can transfer or move electrical charge. Conductive and semi-conductive components include, but are not limited to, a metal, a nanoparticle, a polymer, a cream solder, a resin, and combinations thereof. In some embodiments, a conductive component is present in a concentration of about 1% to about 100%, about 1% to about 10%, about 5% to about 100%, about 25% to about 100%, about 50% to about 100%, about 75% to about 99%, about 2%, about 5%, about 90%, about 95% by weight of the patterning composition.

Metals suitable for use in a patterning composition include, but are not limited to, a transition metal, aluminum, silicon, phosphorous, gallium, germanium, indium, tin, antimony, lead, bismuth, alloys thereof, and combinations thereof.

In some embodiments, the patterning composition comprises a semi-conductive polymer. Semi-conductive polymers suitable for use include, but are not limited to, a polyaniline, a poly(3,4-ethylenedioxythiophene)-poly(styrenesulfonate), a polypyrrole, an arylene vinylene polymer, a polyphenylenevinylene, a polyacetylene, a polythiophene, a polyimidazole, and combinations thereof.

The patterning composition can include an insulating component. As used herein, an “insulating component” refers to a compound or species that is resistant to the movement or transfer of electrical charge. In some embodiments, an insulating component has a dielectric constant of about 1.5 to about 8 about 1.7 to about 5, about 1.8 to about 4, about 1.9 to about 3, about 2 to about 2.7, about 2.1 to about 2.5, about 8 to about 90, about 15 to about 85, about 20 to about 80, about 25 to about 75, or about 30 to about 70. Insulating components suitable for use in the methods disclosed herein include, but are not limited to, a polymer, a metal oxide, a metal carbide, a metal nitride, monomeric precursors thereof, particles thereof, and combinations thereof. Suitable polymers include, but are not limited to, a polydimethylsiloxane, a silsesquioxane, a polyethylene, a polypropylene, a polyimide, and combinations thereof. In some embodiments, for example, an insulating component is present in a concentration of about 1% to about 95%, about 1% to about 80%, about 1% to about 50%, about 1% to about 20%, about 1% to about 10%, about 20% to about 95%, about 20% to about 90%, about 40% to about 80%, about 1%, about 5%, about 10%, about 90%, or about 95% by weight of the patterning composition.

The patterning composition can include a masking component. As used herein, a “masking component” refers to a compound or species that upon reacting forms a surface feature resistant to a species capable of reacting with the surrounding surface. Masking components suitable for use include materials commonly employed in traditional photolithography methods as “resists” (e.g., photoresists, chemical resists, self-assembled monolayers, etc.). Masking components suitable for use in the disclosed methods include, but are not limited to, a polymer such as a polyvinylpyrollidone, poly(epichlorohydrin-co-ethyleneoxide), a polystyrene, a poly(styrene-co-butadiene), a poly(4-vinylpyridine-co-styrene), an amine terminated poly(styrene-co-butadiene), a poly(acrylonitrile-co-butadiene), a styrene-butadiene-styrene block copolymer, a styrene-ethylene-butylene block linear copolymer, a polystyrene-block-poly(ethylene-ran-butylene)-block-polystyrene, a poly(styrene-co-maleic anhydride), a polystyrene-block-poly(ethylene-ran-butylene)-block-polystyrene-graft-maleic anhydride, a polystyrene-block-polyisoprene-block-polystyrene, a polystyrene-block-poly(ethylene-ran-butylene)-block-polystyrene, a polynorbornene, a dicarboxy terminated poly(acrylonitrile-co-butadiene-co-acrylic acid), a dicarboxy terminated poly(acrylonitrile-co-butadiene), a polyethyleneimine, a poly(carbonate urethane), a poly(acrylonitrile-co-butadiene-co-styrene), a poly(vinylchloride), a poly(acrylic acid), a poly(methylmethacrylate), a poly(methyl methacrylate-co-methacrylic acid), a polyisoprene, a poly(1,4-butylene terephthalate), a polypropylene, a poly(vinyl alcohol), a poly(1,4-phenylene sulfide), a polylimonene, a poly(vinylalcohol-co-ethylene), a poly[N,N′-(1,3-phenylene)isophthalamide], a poly(1,4-phenylene ether-ether-sulfone), a poly(ethyleneoxide), a poly[butylene terephthalate-co-poly(alkylene glycol) terephthalate], a poly(ethylene glycol) diacrylate, a poly(4-vinylpyridine), a poly(DL-lactide), a poly(3,3′,4,4′-benzophenonetetracarboxylic dianhydride-co-4,4′-oxydianiline/1,3-phenylenediamine), an agarose, a polyvinylidene fluoride homopolymer, a styrene butadiene copolymer, a phenolic resin, a ketone resin, a 4,5-difluoro-2,2-bis(trifluoromethyl)-1,3-dioxane, a salt thereof, and combinations thereof. In some embodiments, a masking component is present in a concentration of about 1% to about 10%, about 1% to about 5%, or about 2% by weight of the patterning composition.

The patterning composition can include a conductive component and a reactive component. For example, a reactive component can promote at least one of: penetration of a conductive component into a surface, reaction between the conductive component and a surface, adhesion between a conductive feature and a surface, promoting electrical contact between a conductive feature and a surface, and combinations thereof. Surface features formed by reacting this patterning composition include conductive features selected from the group consisting of: additive non-penetrating, additive penetrating, subtractive penetrating, and conformal penetrating surface features.

The patterning composition can comprise an etchant and a conductive component, for example, suitable for producing a subtractive surface feature having a conductive feature inset therein.

The patterning composition can comprise an insulating component and a reactive component. For example, a reactive component can promote at least one of: penetration of an insulating component into a surface, reaction between the insulating component and a surface, adhesion between an insulating feature and a surface, promoting electrical contact between an insulating feature and a surface, and combinations thereof. Surface features formed by reacting this patterning composition include insulating features selected from the group consisting of: additive non-penetrating, additive penetrating, subtractive penetrating, and conformal penetrating surface features.

The patterning composition can comprise an etchant and an insulating component, for example, suitable for producing a subtractive surface feature having an insulating feature inset therein.

The patterning composition can comprise a conductive component and a masking component, for example, suitable for producing electrically conductive masking features on a surface.

Other contemplated components of a patterning composition suitable for use with the disclosed methods include thiols, 1,9-nonanedithiol solution, silane, silazanes, alkynes cystamine, N-Fmoc protected amino thiols, biomolecules, DNA, proteins, antibodies, collagen, peptides, biotin, and carbon nanotubes.

For a description of patterning compounds and patterning compositions, and their preparation and use, see Xia and Whitesides, Angew. Chem. Int. Ed., 37, 550-575 (1998) and references cited therein; Bishop et al., Curr. Opinion Colloid & Interface Sci., 1, 127-136 (1996); Calvert, J. Vac. Sci. Technol. B, 11, 2155-2163 (1993); Ulman, Chem. Rev., 96:1533 (1996) (alkanethiols on gold); Dubois et al., Annu. Rev. Phys. Chem., 43:437 (1992) (alkanethiols on gold); Ulman, An Introduction to Ultrathin Organic Films: From Langmuir-Blodgett to Self-Assembly (Academic, Boston, 1991) (alkanethiols on gold); Whitesides, Proceedings of the Robert A. Welch Foundation 39th Conference On Chemical Research Nanophase Chemistry, Houston, Tex., pages 109-121 (1995) (alkanethiols attached to gold); Mucic et al. Chem. Commun. 555-557 (1996) (describes a method of attaching 3′ thiol DNA to gold surfaces); U.S. Pat. No. 5,472,881 (binding of oligonucleotide-phosphorothiolates to gold surfaces); Burwell, Chemical Technology, 4, 370-377 (1974) and Matteucci and Caruthers, J. Am. Chem. Soc., 103, 3185-3191 (1981) (binding of oligonucleotides-alkylsiloxanes to silica and glass surfaces); Grabar et al., Anal. Chem., 67, 735-743 (binding of aminoalkylsiloxanes and for similar binding of mercaptoalkylsiloxanes); Nuzzo et al., J. Am. Chem. Soc., 109, 2358 (1987) (disulfides on gold); Allara and Nuzzo, Langmuir, 1, 45 (1985) (carboxylic acids on aluminum); Allara and Tompkins, J. Colloid Interface Sci., 49, 410-421 (1974) (carboxylic acids on copper); Iler, The Chemistry Of Silica, Chapter 6, (Wiley 1979) (carboxylic acids on silica); Timmons and Zisman, J. Phys. Chem., 69, 984-990 (1965) (carboxylic acids on platinum); Soriaga and Hubbard, J. Am. Chem. Soc., 104, 3937 (1982) (aromatic ring compounds on platinum); Hubbard, Acc. Chem. Res., 13, 177 (1980) (sulfolanes, sulfoxides and other functionalized solvents on platinum); Hickman et al., J. Am. Chem. Soc., 111, 7271 (1989) (isonitriles on platinum); Maoz and Sagiv, Langmuir, 3, 1045 (1987) (silanes on silica); Maoz and Sagiv, Langmuir, 3, 1034 (1987) (silanes on silica); Wasserman et al., Langmuir, 5, 1074 (1989) (silanes on silica); Eltekova and Eltekov, Langmuir, 3,951 (1987) (aromatic carboxylic acids, aldehydes, alcohols and methoxy groups on titanium dioxide and silica); and Lec et al., J. Phys. Chem., 92, 2597 (1988) (rigid phosphates on metals); Lo et al., J. Am. Chem. Soc., 118, 11295-11296 (1996) (attachment of pyrroles to superconductors); Chen et al., J. Am. Chem. Soc., 117, 6374-5 (1995) (attachment of amines and thiols to superconductors); Chen et al., Langmuir, 12, 2622-2624 (1996) (attachment of thiols to superconductors); McDevitt et al., U.S. Pat. No. 5,846,909 (attachment of amines and thiols to superconductors); Xu et al., Langmuir, 14, 6505-6511 (1998) (attachment of amines to superconductors); Mirkin et al., Adv. Mater. (Weinheim, Ger.), 9, 167-173 (1997) (attachment of amines to superconductors); Hovis et al., J. Phys. Chem. B, 102, 6873-6879 (1998) (attachment of olefins and dienes to silicon); Hovis et al., Surf. Sci., 402-404, 1-7 (1998) (attachment of olefins and dienes to silicon); Hovis et al., J. Phys. Chem. B, 101, 9581-9585 (1997) (attachment of olefins and dienes to silicon); Hamers et al., J. Phys. Chem. B, 101, 1489-1492 (1997) (attachment of olefins and dienes to silicon); Hamers et al., U.S. Pat. No. 5,908,692 (attachment of olefins and dienes to silicon); Ellison et al., J. Phys. Chem. B, 103, 6243-6251 (1999) (attachment of isothiocyanates to silicon); Ellison et al., J. Phys. Chem. B, 102, 8510-8518 (1998) (attachment of azoalkanes to silicon); Ohno et al., Mol. Cryst. Liq. Cryst. Sci. Technol., Sect. A, 295, 487-490 (1997) (attachment of thiols to GaAs); Reuter et al., Mater. Res. Soc. Symp. Proc., 380, 119-24 (1995) (attachment of thiols to GaAs); Bain, Adv. Mater. (Weinheim, Fed. Repub. Ger.), 4, 591-4 (1992) (attachment of thiols to GaAs); Sheen et al., J. Am. Chem. Soc., 114, 1514-15 (1992) (attachment of thiols to GaAs); Nakagawa et al., Jpn. J. Appl. Phys., Part 1, 30, 3759-62 (1991) (attachment of thiols to GaAs); Lunt et al., J. Appl. Phys., 70, 7449-67 (1991) (attachment of thiols to GaAs); Lunt et al., J. Vac. Sci. Technol., B, 9, 2333-6 (1991) (attachment of thiols to GaAs); Yamamoto et al., Langmuir ACS ASAP, web release number Ia990467r (attachment of thiols to InP); Gu et al., J. Phys. Chem. B, 102, 9015-9028 (1998) (attachment of thiols to InP); Menzel et al., Adv. Mater. (Weinheim, Ger.), 11, 131-134 (1999) (attachment of disulfides to gold); Yonezawa et al., Chem. Mater., 11, 33-35 (1999) (attachment of disulfides to gold); Porter et al., Langmuir, 14, 7378-7386 (1998) (attachment of disulfides to gold); Son et al., J. Phys. Chem., 98, 8488-93 (1994) (attachment of nitriles to gold and silver); Steiner et al., Langmuir, 8, 2771-7 (1992) (attachment of nitriles to gold and copper); Solomun et al., J. Phys. Chem., 95, 10041-9 (1991) (attachment of nitriles to gold); Solomun et al., Ber. Bunsen-Ges. Phys. Chem., 95, 95-8 (1991) (attachment of nitriles to gold); Henderson et al., Inorg. Chim. Acta, 242, 115-24 (1996) (attachment of isonitriles to gold); Huc et al., J. Phys. Chem. B, 103, 10489-10495 (1999) (attachment of isonitriles to gold); Hickman et al., Langmuir, 8, 357-9 (1992) (attachment of isonitriles to platinum); Steiner et al., Langmuir, 8, 90-4 (1992) (attachment of amines and phospines to gold and attachment of amines to copper); Mayya et al., J. Phys. Chem. B, 101, 9790-9793 (1997) (attachment of amines to gold and silver); Chen et al., Langmuir, 15, 1075-1082 (1999) (attachment of carboxylates to gold); Tao, J. Am. Chem. Soc., 115, 4350-4358 (1993) (attachment of carboxylates to copper and silver): Laibinis et al., J. Am. Chem. Soc., 114, 1990-5 (1992) (attachment of thiols to silver and copper); Laibinis et al., Langmuir, 7, 3167-73 (1991) (attachment of thiols to silver); Fenter et al., Langmuir, 7, 2013-16 (1991) (attachment of thiols to silver); Chang et al., Am. Chem. Soc., 116, 6792-805 (1994) (attachment of thiols to silver); Li et al., J. Phys. Chem., 98, 11751-5 (1994) (attachment of thiols to silver); Li et al., Report, 24 pp (1994) (attachment of thiols to silver); Tarlov et al., U.S. Pat. No. 5,942,397 (attachment of thiols to silver and copper); Waldeck, et al., PCT application WO/99/48682 (attachment of thiols to silver and copper); Gui et al., Langmuir, 7, 955-63 (1991) (attachment of thiols to silver); Walczak et al., J. Am. Chem. Soc., 113, 2370-8 (1991) (attachment of thiols to silver); Sangiorgi et al., Gazz. Chim. Ital., 111, 99-102 (1981) (attachment of amines to copper); Magallon et al., Book of Abstracts, 215th ACS National Meeting, Dallas, Mar. 29-Apr. 2, 1998, COLL-048 (attachment of amines to copper); Patil et al., Langmuir, 14, 2707-2711 (1998) (attachment of amines to silver); Sastry et al., J. Phys. Chem. B, 101, 4954-4958 (1997) (attachment of amines to silver); Bansal et al., J. Phys. Chem. B. 102, 4058-4060 (1998) (attachment of alkyl lithium to silicon); Bansal et al., J. Phys. Chem. B, 102, 1067-1070 (1998) (attachment of alkyl lithium to silicon); Chidsey, Book of Abstracts, 214th ACS National Meeting, Las Vegas, Nev., Sep. 7-11, 1997, I&EC-027 (attachment of alkyl lithium to silicon); Song, J. H., Thesis, University of California at San Diego (1998) (attachment of alkyl lithium to silicon dioxide); Meyer et al., J. Am. Chem. Soc., 110, 4914-18 (1988) (attachment of amines to semiconductors); Brazdil et al. J. Phys. Chem., 85, 1005-14 (1981) (attachment of amines to semiconductors); James et al., Langmuir, 14, 741-744 (1998) (attachment of proteins and peptides to glass); Bernard et al., Langmuir, 14, 2225-2229 (1998) (attachment of proteins to glass, polystyrene, gold, silver and silicon wafers); Pereira et al., J. Mater. Chem., 10, 259 (2000) (attachment of silazanes to SiO₂); Pereira et al., J. Mater. Chem., 10, 259 (2000) (attachment of silazanes to SiO₂); Dammel, Diazonaphthoquinone Based Resists (1st ed., SPIE Optical Engineering Press, Bellingham, Wash., 1993) (attachment of silazanes to SiO₂); Anwander et al., J. Phys. Chem. B, 104, 3532 (2000) (attachment of silazanes to SiO₂); Slavov et al., J. Phys. Chem., 104, 983 (2000) (attachment of silazanes to SiO₂).

### Substrates to be Patterned

Suitable substrates can include any material that supports the surface for immobilizing the biological species. In one type of embodiment, the substrate itself is inert in that it is incapable of specifically binding the biological species or immobilizing a metal ion alone, i.e., the substrate itself does not have functionalized surface. In one aspect, relatively smooth substrates are utilized which provide for subsequent high resolution printing. Substrates can be cleaned and used soon after cleaning to prevent contamination. In other aspects, the substrate is one that has been treated with one or more adsorbates.

Substrates suitable for use in methods disclosed herein include, but are not limited to, metals, alloys, composites, crystalline materials, amorphous materials, conductors, semiconductors, optics, fibers, inorganic materials, glasses, ceramics (e.g., metal oxides, metal nitrides, metal silicides, and combinations thereof), zeolites, polymers, plastics, organic materials, minerals, biomaterials, living tissue, bone, films thereof, thin films thereof, laminates thereof, foils thereof, composites thereof, and combinations thereof. A substrate can comprise a semiconductor such as, but not limited to: crystalline silicon, polycrystalline silicon, amorphous silicon, p-doped silicon, n-doped silicon, silicon oxide, silicon germanium, germanium, gallium arsenide, gallium arsenide phosphide, indium tin oxide, and combinations thereof. A substrate can comprise a glass such as, but not limited to, undoped silica glass (SiO₂), fluorinated silica glass, borosilicate glass, borophosphorosilicate glass, organosilicate glass, porous organosilicate glass, and combinations thereof. The substrate can be a non-planar substrate, such as pyrolytic carbon, reinforced carbon-carbon composite, a carbon phenolic resin, and the like, and combinations thereof. A substrate can comprise a ceramic such as, but not limited to, silicon carbide, hydrogenated silicon carbide, silicon nitride, silicon carbonitride, silicon oxynitride, silicon oxycarbide, high-temperature reusable surface insulation, fibrous refractory composite insulation tiles, toughened unipiece fibrous insulation, low-temperature reusable surface insulation, advanced reusable surface insulation, and combinations thereof. A substrate can comprise a flexible material, such as, but not limited to: a plastic, a metal, a composite thereof, a laminate thereof, a thin film thereof, a foil thereof, and combinations thereof. See International Patent Publication No. WO 2009/132321 and see International Patent Application No. PCT/US2010/024631, the entire disclosures of which are incorporated herein by reference for a description of examples of suitable substrates for use with Polymer Pen Lithography and Gel Pen Lithography, respectively.

Suitable metals include, but are not limited to gold, silver, aluminum, copper, platinum and palladium. Other substrates onto which compounds may be patterned include, but are not limited to silica, silicon oxide, GaAs, and InP. Still other exemplary substrates are described in United States Patent Application 2003/0068446 and include those comprising silicon, silicon oxide, silicon dioxide, silicon nitride, Teflon®, alumina, glass, sapphire, a selinide, or polyester. Still other exemplary substrates in those made out of sapphire, quartz, nitrides, arsenides, carbides, oxides, phosphides, selinides or plastics. Still other substrate materials include Al₂O₃, ZrO₂, Fe₂O₃, Ag₂O, Zr₂O₃, Ta₂O₅, zeolite, TiO₂, glass, indium tin oxide, hydroxyapatite, calcium phosphate, calcium carbonate, Au, Fe₃O₄, ZnS, CdSe and combinations thereof. An organic biocompatible carrier material may be a material including, but not limited to, polypropylene, polystyrene, polyacrylates and mixtures thereof.

In one embodiment, the substrate consists of or comprises a biodegradable material. The biodegradable material is stable for the period of use, but may thereafter be degraded to result in excretable fragments. These are in particular polyesters of polylactic acid which have been additionally stabilized by crosslinking and are biodegradable in a controlled fashion. Exemplary substrates of this type include without limitation a polyester of polylactic acid and in particular, poly(D,L-lactic acid-co-glycolic acid) (PLGA).

The surfaces to pattern by BPL can include any suitable substrate, and preferably one which can be advantageously affected by exposure to radiation. See International Patent Publication No. WO 2010/096593, the entire disclosure of which is incorporated herein by reference. For example, the substrate can be photosensitive or can include a photosensitive layer. For example, the photosensitive substrate or photosensitive layer can be a resist layer. The resist layer can be any known resist material, for example SHIPLEY1805 (MicroChem. Inc.). Other suitable resist materials include, but are not limited to, Shipley1813 (MicroChem. Inc.), Shipley1830 (MicroChem. Inc.), PHOTORESIST AZ1518 (MicroChemicals, Germany), PHOTORESIST AZ5214 (MicroChemicals, Germany), SU-8, and combinations thereof. Other examples of photosensitive materials include, but are not limited to, liquid crystals and metals. For examples, the substrate can include metal salts that can be reduced when exposed to the radiation. Substrates suitable for use in methods disclosed herein include, but are not limited to, metals, alloys, composites, crystalline materials, amorphous materials, conductors, semiconductors, optics, fibers, inorganic materials, glasses, ceramics (e.g., metal oxides, metal nitrides, metal silicides, and combinations thereof), zeolites, polymers, plastics, organic materials, minerals, biomaterials, living tissue, bone, and laminates and combinations thereof. The substrate can be in the form of films, thin films, foils, and combinations thereof. A substrate can comprise a semiconductor including, but not limited to one or more of: crystalline silicon, polycrystalline silicon, amorphous silicon, p-doped silicon, n-doped silicon, silicon oxide, silicon germanium, germanium, gallium arsenide, gallium arsenide phosphide, indium tin oxide, graphene, and combinations thereof. A substrate can comprise a glass including, but not limited to, one or more of undoped silica glass (SiO₂), fluorinated silica glass, borosilicate glass, borophosphorosilicate glass, organosilicate glass, porous organosilicate glass, and combinations thereof. The substrate can be a non-planar substrate, including, but not limited to, one or more of pyrolytic carbon, reinforced carbon-carbon composite, a carbon phenolic resin, and combinations thereof. A substrate can comprise a ceramic including, but not limited to, one or more of silicon carbide, hydrogenated silicon carbide, silicon nitride, silicon carbonitride, silicon oxynitride, silicon oxycarbide, high-temperature reusable surface insulation, fibrous refractory composite insulation tiles, toughened unipiece fibrous insulation, low-temperature reusable surface insulation, advanced reusable surface insulation, and combinations thereof. A substrate can comprise a flexible material, including, but not limited to one or more of: a plastic, a metal, a composite thereof, a laminate thereof, a thin film thereof, a foil thereof, and combinations thereof.

The photosensitive substrate or the photosensitive layer can have any suitable thickness, for example in a range of about 100 nm to about 5000 nm. For example, the minimum photosensitive substrate or photosensitive layer thickness can be about 100, 150, 200, 250, 300, 350, 400, 450 or 500, 550, 600, 650, 700, 750, 800, 850, 900, 950, 1000, 1500, 2000, 2500, 3000, 3500, 4000, 4500, or 5000 nm. For example, the maximum photosensitive substrate or photosensitive layer thickness can be about 100, 150, 200, 250, 300, 350, 400, 450 or 500, 550, 600, 650, 700, 750, 800, 850, 900, 950, 1000, 1500, 2000, 2500, 3000, 3500, 4000, 4500, or 5000 nm. The diameter of the indicia formed by the pen array can be modulated by modifying the resist material used and/or the thickness of the photosensitive substrate or photosensitive layer. For example, under the same radiation conditions, a thicker photosensitive layer can result in indicia having larger diameters. At constant photosensitive layer thickness, an increase in radiation intensity can results in indicia having larger diameters.

### Analyte Interacting Element

The analyte interacting element can include, for example, alkanethiols, peptide-functionalized thiols, proteins, polypeptides, olgionucleotides, polysaccharides, and lipids. The analyte interacting element can include bioconjucation chemistries, including but not limited to, N-hydroxysuccinimide esters, maleimides, amines, copper-catalyzed azide-alkyne click reaction.

In various embodiments, the analyte interacting element can be a protein, for example, an extracellular matrix protein. Proteins that are easily immobilized on a pattern element can include those that have distinct moieties for attachment to the pattern element. For example, the protein can include a moiety that is imidazole/carboxylate rich. Proteins include naturally-occurring proteins, synthetic proteins, and proteins that are partially naturally occurring and partially synthetic, and fragments of any of the foregoing. Examples of proteins for use as analyte interacting elements include, for example, adhesion proteins, including fibronectin.

The analyte interacting element can be, for example, an antibody, including but not limited to polyclonal antibodies, monoclonal antibodies and derivatives thereof including for example and without limitation chimeric antibodies, humanized antibodies, single chain antibodies, bi- or multispecific antibodies, and chelating recombinant antibodies. It will be apparent to the person of ordinary skill, in view of the present disclosure, that other antibody derivatives are useful in the methods. For example, immobilization of synthetic antibodies is contemplated, including, for example and without limitation, substitution, addition, and deletion variants that maintain metal ion binding capacity through Fc region interaction. It is understood in the art that a substitution derivative is one which includes one or more amino acid substitutions, an addition derivation is one that includes deletion of one or more amino acid residues and a deletion derivation is one that includes deletion of one or more amino acid residues. Still other antibody derivatives include antibody fusion proteins.

The analyte interacting element can be, for example, a metal binding protein, which interacts with a metal ion in such a manner that the protein immobilized on a surface through metal ion binding maintains the ability to interact with a binding partner, including an antibody. All derivatives of metal binding proteins in the discussion of antibodies above are contemplated as well. In one aspect, the metal binding site, or the moiety in or on which it is located, is distal to the binding partner binding site or moiety.

Metal binding proteins amenable for use in the methods provided are well known in the art and are designated 1.10.220.10 in the CATH protein structure classification. The “metalloproteome” is defined as the set of proteins that have metal-binding capacity by being metalloproteins or having metal-binding sites. A different metalloproteome may exist for each metal.

Other suitable analyte interacting elements can include, for example, metastasis factors, such as matrix metalloproteinase-1 (MMP-1), metastasin (Mts1/S100A4), p37, and tumour invasion and metastasis factor (TIAM1); proteins for signal TO neurons; extracellular matrix proteins, such as collagen, laminin, vitronectin, elastin, and fibronectin; tissue engineering materials, such as Matrigel, and poly-lysine; cytokines (or growth factors), such as angiopoietin (Ang), bone morphogenic proteins (BMP), epidermal growth factor (EGF), fibroblast growth factor (FGF), transforming growth factor (TGF), and vascular endothelial growth factor (VEGF).

### Analyte

The analyte can be, for example, a biological species, such as, for example, a cell or a virus. The term “cells” embraces eukaryotic cells, prokaryotic cells, fungal cells, and recombinantly engineered derivatives thereof. The term “virus” embraces virulent strains, strains with attenuated virulence and strains which completely lack virulence (e.g., virus-like particles). The term “virus” also embraces bacteriophage. Examples of analytes include cancer cells, nerve cells, and stem cells, for example, mesenchymal stem cells.

The analyte can also include non-biological systems, including but not limited to metallic, semiconducting, and insulating inorganic and organic structures. Such structures can be used, for example, their electronic, optical, magnetic, or plasmonic properties. In various embodiments, one or more of these properties can be the analyte parameter.

### Generation of Combinatorial Libraries to Probe Mesenchymal Stem Cell Differentiation

Recently, it has been observed that environmental factors such as substrate stiffness (6), topography (7, 8), geometry (9, 10), and chemical cues (11, 12) can guide stem cell fate. However, the exact structures and cues which govern such responses are not well known. A method in accordance with the present disclosure allows for the generation of combinatorial libraries of biomolecular-based nanostructures using a tool that enables precise control of feature size, spacing, and biochemical composition for systematic and simultaneous investigation of such factors on biological processes in statistically relevant populations of cells. As described in detail above, tilted elastomeric pyramid array coupled with polymer pen lithography (PPL) can be used to rapidly fabricate custom combinatorial libraries with as many as 40 million nano- and microscale biomolecular features that are positionally encoded over square centimeter areas. For example, an elastomeric array of pyramidal pens can be used to deliver a material, for example, alkanethiols or proteins, to a surface for generating customizable patterns with feature sizes ranging from the nano- to microscale simply by changing the amount of force applied (1).

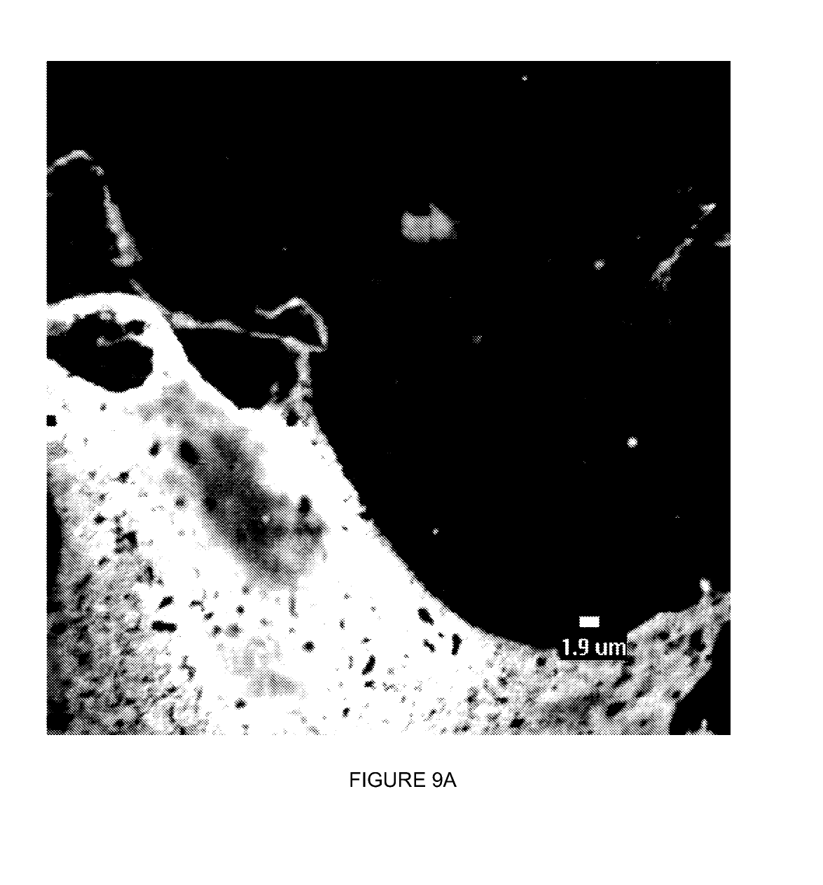

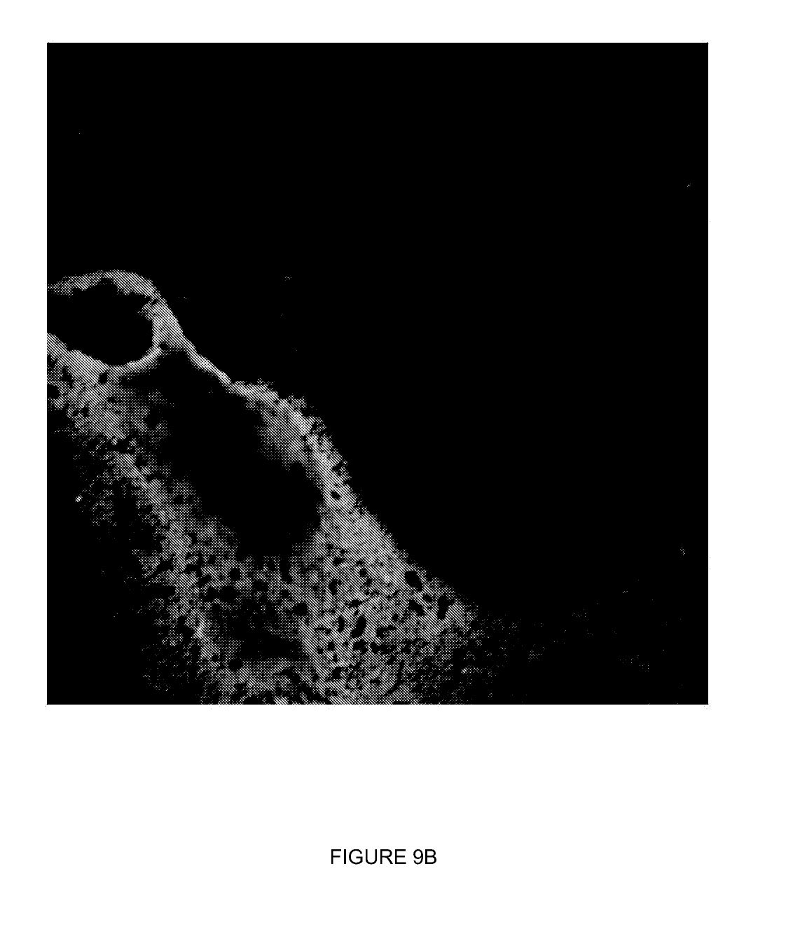

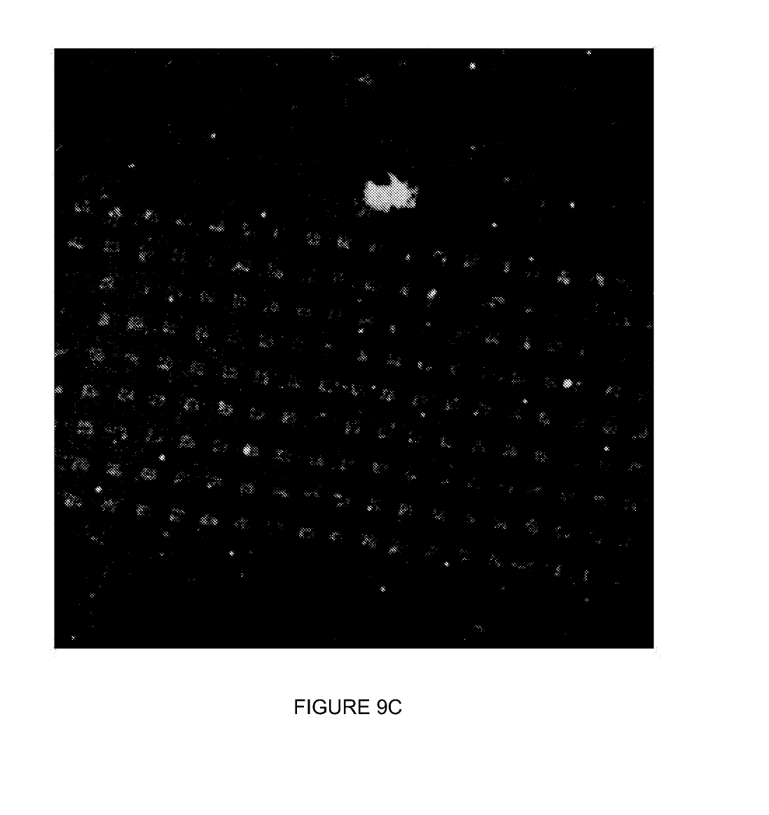

The tilted array can be used to print patterns of small molecules that bind to an ECM protein (e.g., fibronectin), which subsequently interacts with a cell's focal adhesion complexes, which enables stem cells to adhere to the surface of the combinatorial array, as shown in FIG. 9A. FIGS. 9B and 9C show the stem cell and the combinatorial array of FIG. 9A, respectively.

In accordance with a method of the disclosure, the combinatorial approach was used to identify extracellular matrix protein feature sizes that facilitate mesenchymal stem cell (MSC) adhesion, and then PPL was used with the same polymer pen array used to generate the combinatorial patterns, to fabricate homogeneous patterns over large areas to further investigate how each of the identified feature sizes affect MSC differentiation. In contrast to previous studies, which have relied on other lithographic techniques such as microcontact printing (17), electron beam lithography (7), or scanning probe lithography (18, 19) to fabricate arrays of structures for investigating one parameter at a time, the methods disclosed herein allow for rapid screening of a large number of feature sizes and structures to identify promising feature sizes and/or structures that affect differentiation. Once promising feature size and/or structures have been identified using the combinatorial approach, a uniform (i.e., homogenous) pattern of this identified feature sizes and/or structure can be generated to further study the effect in a more statistically significant number, conveniently using the same PPL array if desired.

In various embodiments, and particularly embodiments studying the effect of feature size on cell differentiation, fibronectin was used as the analyte interacting element. Fibronectin is an extracellular matrix protein that is known to bind the as integrin receptors of cell membranes via the Arg-Gly-Asp (RGD) domain (20). Upon cell adhesion and spreading, these integrin receptors aggregate and assemble into multimolecular complexes termed focal adhesions, which have been implicated in cell mechanosensing and mechanotransduction (21). Previous observations have shown that MSCs can differentiate into neurogenic, myogenic, adipogenic, and osteogenic fates, each having characteristically different focal adhesion sizes, which span the nanometer to micrometer scale (6, 9, 10). Consequently, the ability to control the focal adhesion size may guide MSC differentiation towards a specific lineage without the use of biochemical cues. Methods in accordance with embodiments of the disclosure were used to investigate whether nanometer or micrometer fibronectin feature size and spacing affects MSC differentiation towards an osteogenic lineage. It was observed that MSCs cultured on fibronectin patterns having 300 nm features spaced 1.2 μm apart and grown in the absence of osteogenesis-promoting factors had increased expression of osteogenic markers at both the RNA and protein level.

In various embodiments of the methods of the disclosure, a combinatorial array of pattern sizes was used to qualitatively analyze the effect of feature size on an analyte parameter of interest and identify one or more feature sizes having a desired effect on the analyte parameter. Uniform patterns of the feature sizes identified having the desired effect on the analyte were then produced to quantitatively characterize the effect. For example, in one embodiment combinatorial patterns can be used to qualitatively investigate osteogenic marker expression in individual cells by immunofluorescence, while the uniform patterns of an identified feature size can be used to quantitatively measure the expression of osteogenic markers at the mRNA and protein levels for cell populations. By using a method in accordance with the disclosure, it has been observed that when the total amount of fibronectin presented to each MSC is held constant, substrates consisting of nanoscale features promote the expression of osteogenic markers in MSCs to a greater extent than both unpatterned surfaces and substrates consisting of micrometer scale features. It should be understood that while embodiments of the method of the disclosure are exemplified herein with reference to MSC differentiation, the methods disclosed herein can be used to analyze how the biomolecular and physical composition of the surrounding cellular environment affects fundamental cell processes.

Additional aspects and details of the disclosure will be apparent from the following examples, which are intended to be illustrative rather than limiting.

### Example

### Substrate Preparation

Glass coverslips (Fisher®) were rinsed in pure ethanol and dried under a stream of N₂. They were mounted in an electron-beam evaporator (Lesker) and when vacuum reached 2×10⁻⁷ mTorr, a 4 nm layer of Ti and a 14 nm layer of Au were evaporated onto the glass coverslips.

To pattern substrates, a square-inch polydimethysiloxane (PDMS) polymer pen array attached to a glass support made according to published methods (2) was coated with a 10 mM ethanolic solution of 16-mercaptohexadecanoic acid (MHA) and blown dry with nitrogen. Afterwards, the pen array was mounted in a scanning probe instrument (XE-150, Park Systems®) equipped with a tilt stage and a decoupled x- and y-piezo 100-μm closed loop scanner inside an environmental chamber having humidity control. Commercial lithography software (XEL, Park Systems®) provides customizable control over position, tip-substrate contact time (0.1 to 0.5 sec), amount of z-piezo extension (range of ˜25 μm), and z-piezo extension speed (100 μm/sec) for each feature in a desired pattern. The polymer pen array can be aligned by top-down optical observation of tip deformation using a microscope (2) or force maximization strategies (23).

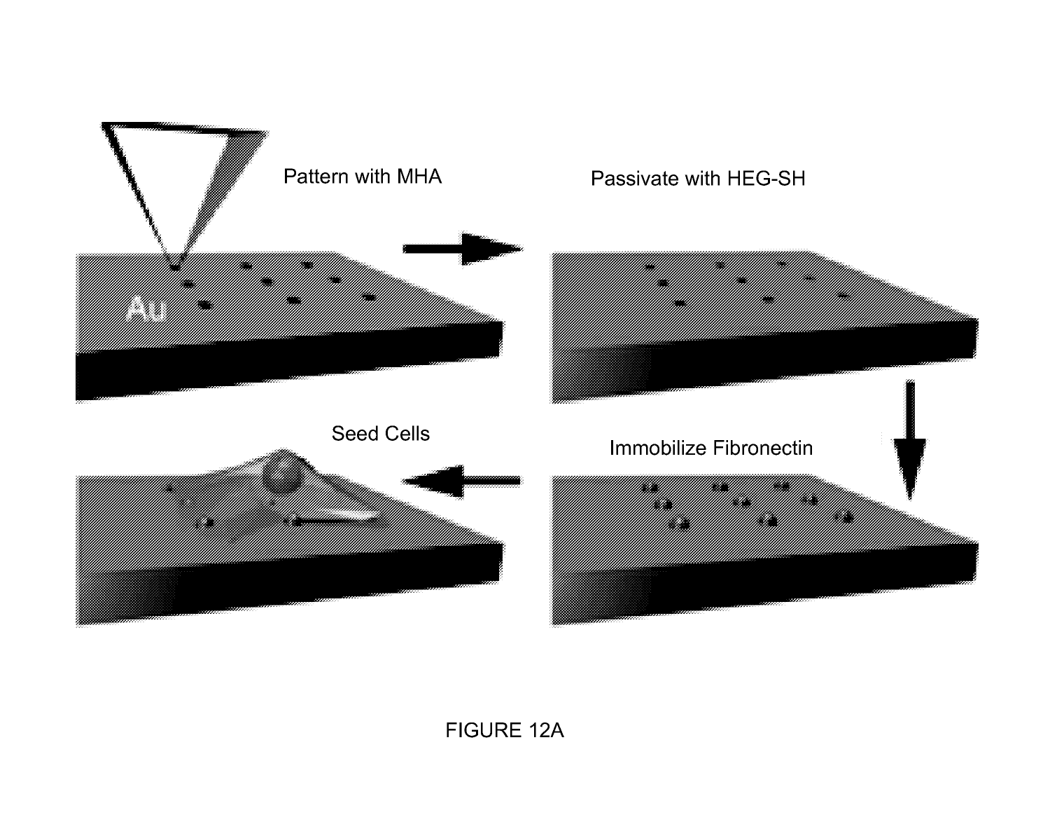

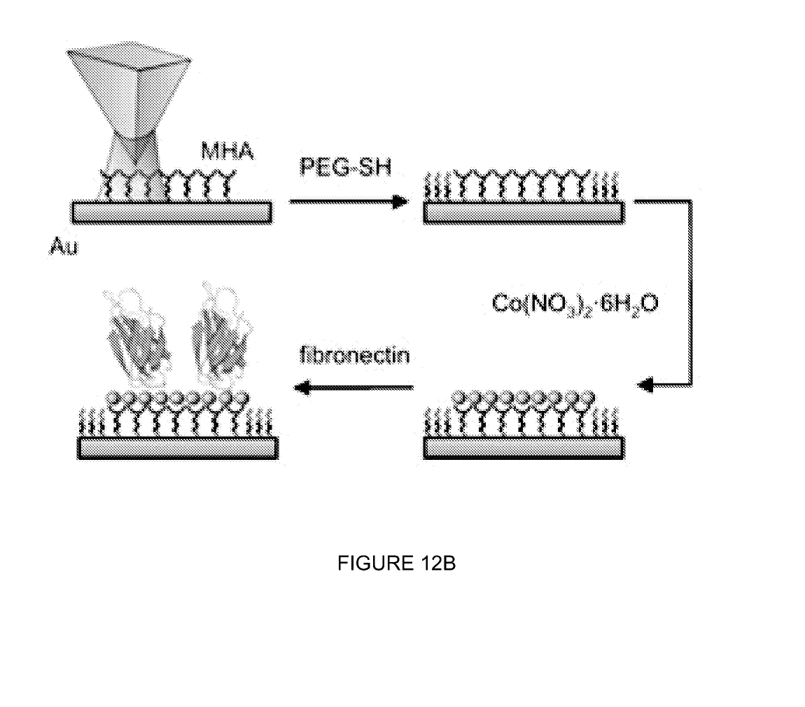

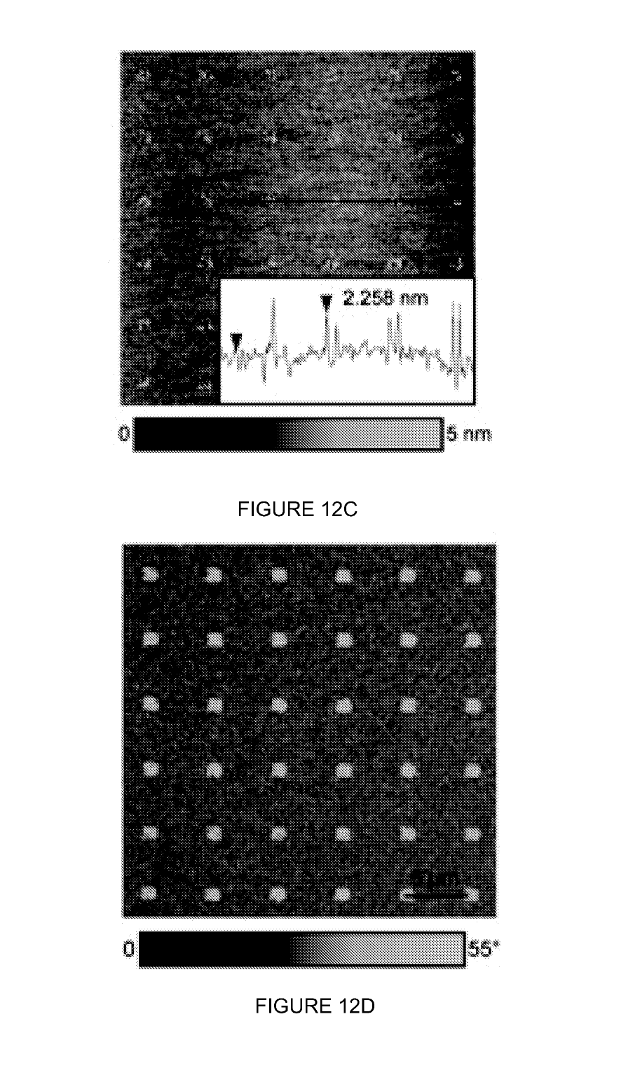

The inked pen array was used to pattern self-assembled monolayers of MHA on an electron-beam evaporated gold substrate (14 nm Au layer with a 4 nm Ti adhesion layer on #1 cover slip glass). A portion of these large area patterns was chemically etched to produce raised Au features that were used to confirm pattern quality and feature size either by optical or scanning electron microscopes (SEM). By intentionally tilting the polymer pen array about 0.01°, it was possible to generate combinatorial patterns having different feature sizes, but the same feature pitch or spacing (FIGS. 11A, 11B, and 11E). Uniform Au feature dimensions ranging from 475 nm to 1.2 μm were fabricated in this manner and observed using SEM (FIGS. 11C, 11D, and 11F). The remaining unetched patterned substrate was passivated using a 1 mM ethanolic solution of hexa(ethylene glycol)-undecanethiol for 1 hour at room temperature to reduce non-specific protein adsorption (FIGS. 12A and 12B). The substrate was rinsed with ethanol and dried with nitrogen before immersion in a 10 mM ethanolic solution of cobalt nitrate for 1 hour at room temperature. In this step, cobalt cations chelated the carboxylic acid groups in MHA, which enabled selective orientation of fibronectin that did not affect the cell-binding domain of the protein (FIGS. 12A and 12B) (24). A single and dense layer of human fibronectin was immobilized on the substrates as measured by AFM (FIGS. 12B and 12C). Given that an “adhesive unit” of about 60 nm has at least four clustered integrin heterodimers, fibronectin features having diameters of 300 nm and 1 μm could support contact of at least 100 to 1400 integrins, respectively (25).

### Cell Culture

Human MSCs (Lonza®) were cultured in normal growth medium at 37° C. with 5% CO₂ that was supplemented with MSC growth supplement (Lonza®) and L-glutamine (Lonza®). The cells were used before passage 2. For chemical induction of differentiation, cells were cultured in osteogenic media (Lonza®) which is normal growth medium supplemented with dexamethasone, ascorbic acid, penicillin/streptomycin, and β-glycerophosphate. Substrate plating densities were 5000 cells/cm² of substrate.

Because the distance between pens in the array is 80 μm, each substrate can have as many as 15,625 individual patterns per square centimeter. Typically, a seeding density of 5000 cells/mL is used for each square centimeter substrate. These cell seeding densities do not contribute towards osteogenic differentiation (5, 20). Several protein and transcription factor markers indicative of osteogenic commitment were used to analyze how patterns of fibronectin may affect differentiation: alkaline phosphatase (ALP), osteocalcin (OCN), osteopontin (OPN), core-binding factor-α (CBF-α), and transcriptional coactivator with PDZ-motif (TAZ) (21).

### Identification of Relevant Feature Sizes Using a Combinatorial Array

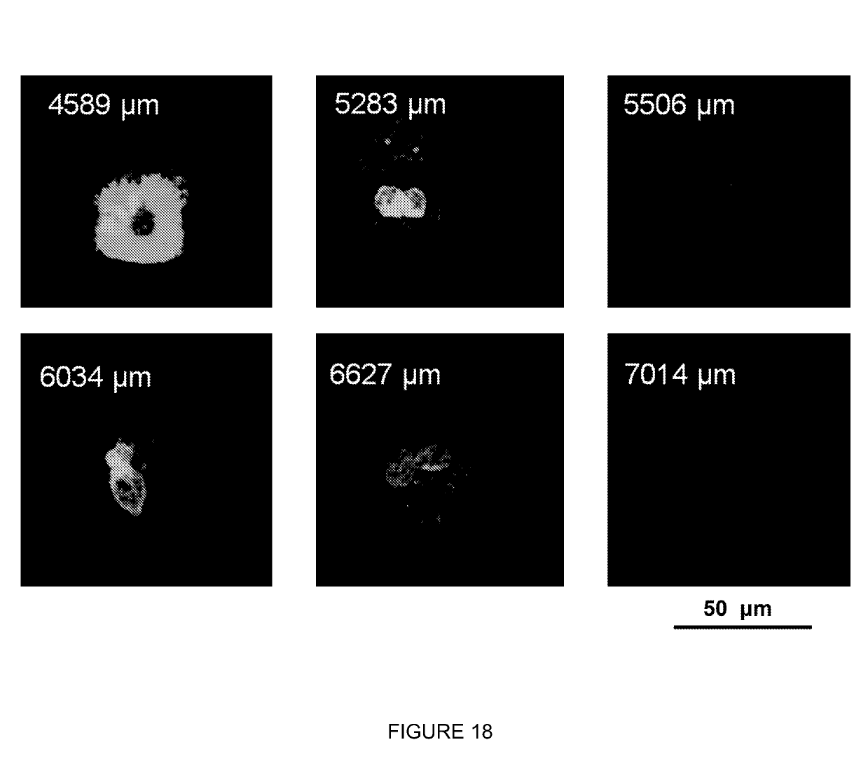

Tilted polymer pen arrays were used to fabricate substrates where fibronectin feature sizes varied across the individual patterns. These substrates enabled combinatorial investigation of MSC attachment, viability, and osteogenic marker expression (FIG. 18). FIG. 18 is the immunofluorescence images of MSCS cultured on combinatorial fibronectin patterns using a tilted pen array (180×180 μm pen spacing), where each pen made a 15×15 array of features spaced by 4 m (i.e., each pen had tips spaced by 4 μm). After one week, cells were stained for ALP, actin, and the nucleus. Labels (4589, 5283, 5506, 6034, 6627, and 7014 μm) indicate the x-position across the pattern substrate and correspond to a certain protein feature size. Squaring average protein feature size and then multiplying by 225 yields the total protein area presented to the cell. The calculated results are shown in Table 1, below.

TABLE 1

| | Average | Total protein |
|---|---|---|
| Position across | protein feature | area presented to |
| substrate (μm) | size (μm) | cell (μm²) |
| 4589 | 1.725 | 670 |
| 5283 | 1.375 | 425 |
| 5506 | 1.150 | 298 |
| 6034 | 1.050 | 248 |
| 6627 | 0.900 | 182 |
| 7014 | 0.700 | 110 |

It was determined that cells are fully spread, incompletely spread, and not attached to fibronectin patterns having total protein areas of 248 μm², 182 μm², and 110 μm², respectively.

It was identified that even when the total projected cell area was held constant at 3600 μm² (square pattern of 60 μm×60 μm), the total fibronectin contact area per cell controls MSC adhesion. When a MSC is exposed to only 182 μm² of immobilized fibronectin, the MSC did not fully spread on the pattern regions, whereas at 248 μm² of fibronectin, the MSC covered the entire 60×60 μm pattern. These results are consistent with previous observations that capillary epithelial cell survival requires large projected cell areas and a minimum level of fibronectin contact area (26). Based on these results from the combinatorial array study, 225 μm² was selected as the total fibronectin contact area sufficient for testing if and how fibronectin feature size affects differentiation of MSCs towards osteogenic fates.

Quantitative Analysis Using a Pattern with Uniform Feature Sizes

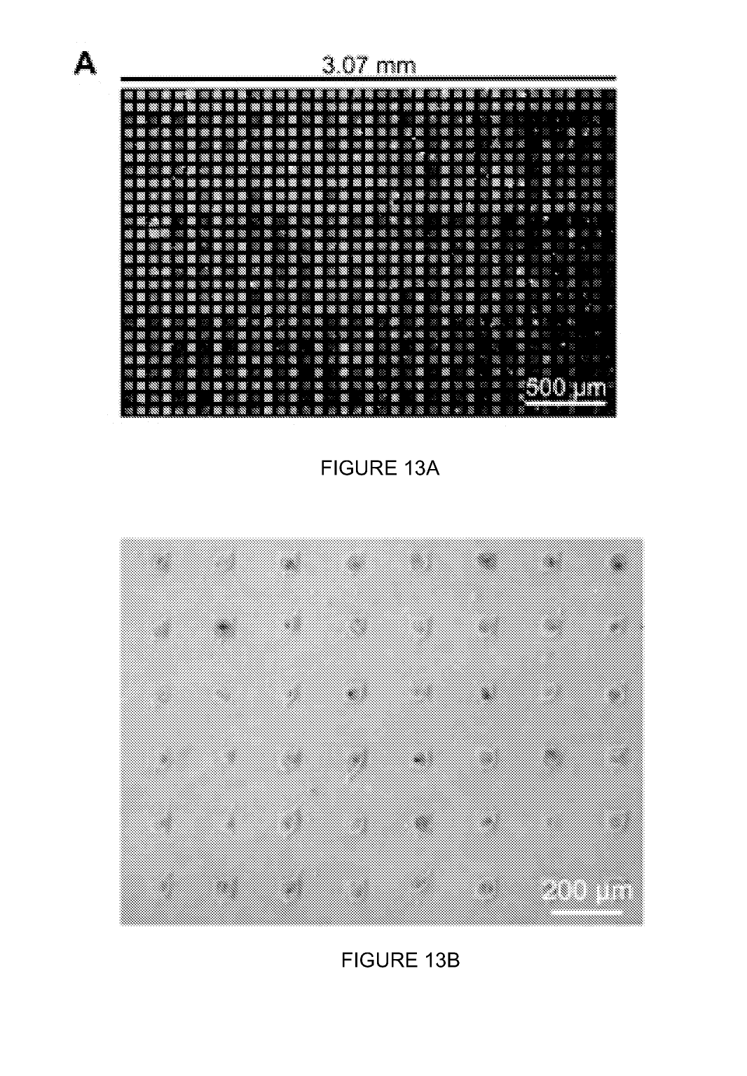

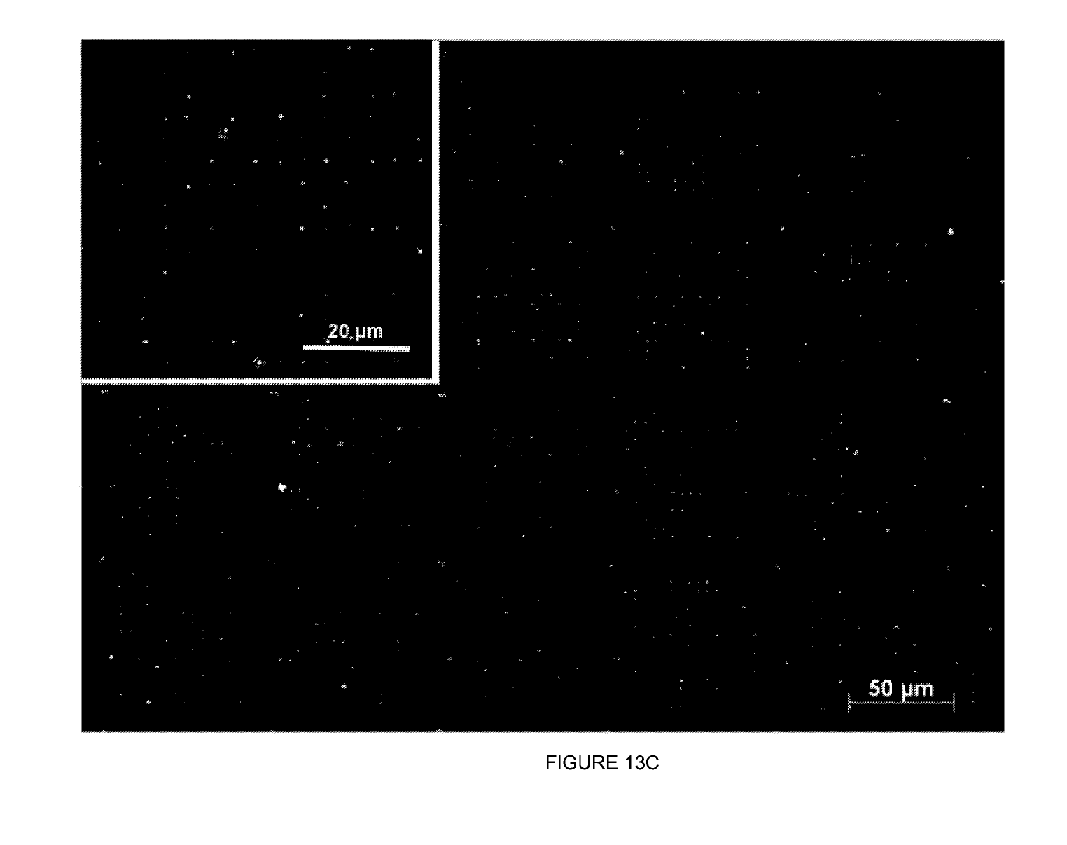

Based on the identification of relevant feature sizes for affect differentiation, level polymer pen arrays were used to fabricate patterns having uniform feature size for two identified feature sizes; 1 μm and 300 nm (FIGS. 13A and 13C). Importantly, total fibronectin surface area was held constant at 225 μm² for 1 μm and 300 nm feature sizes by controlling the feature density. FIGS. 8A and 8B illustrate the polymer pen arrays having different pitches to maintain a constant feature density despite the change in feature size between the two pen arrays. Specifically, the 1 μm features were made in a 15×15 array with a 4 μm pitch and the 300 nm features were made in a 50×50 array with a 1.2 μm pitch. MSCs were seeded on these substrates (FIG. 13B) and cultured in normal growth media or osteogenic media (OM) containing chemical factors ascorbic acid, β-glycerophosphate, and dexamethasone, a critical component known to induce osteogenesis (27). The large uniform patterns allowed for quantitative measurement of expression of osteogenic markers at the mRNA and protein levels across entire cell populations.

More specifically, a 1.8×1.8 cm² pen array having 10,000 pens (spacing between pens=180 μm) was used to prepare patterned substrates. The distance between pens within an array can be easily modified by using different pen molds (FIG. 8A). Given that each pen only made one pattern in this method, 10,000 patterns were made on a substrate; the 180 μm pattern separation corresponds to a density of approximately 3000 patterns/cm². If a single cell occupies every pattern, the cell density remains about 3000 cells/cm²; MSCs seeded at this density do not contribute to cell density-dependent observations of osteogenic differentiation (13, 27). When each pen in a 10,000 pen array prints a single pattern spanning 60×60 μm (15×15 array of 1 μm MHA features spaced 4 μm apart or 50×50 array of 300 nm MHA features spaced 1.2 μm apart), 2.25 million to as many as 25 million individual features are generated on a substrate in about 5 and 25 min, respectively. Rather than only relying on time-dependent ink diffusion from the tip as with conventional dip-pen nanolithography (3, 28), PPL can rapidly access large features (>1 μm) so that substrate preparation is not prohibitively time-consuming for subsequent experiments. Importantly, PPL itself allows one to prepare any custom pattern comprised of complex nanoscale to microscale features and is not limited to the relatively simple square arrays used in this study.

Each pen array was dipped in a 10 mM 16-mercaptohexadecanoic acid solution in ethanol for 5 sec and blown dry with N₂. After mounting the Au substrate and pen array on a scanning probe lithography instrument (Park Systems®), the chamber relative humidity was increased to 45% for patterning. The scanning probe lithography instrument stage can be tilted and aligned with the pen array according to established procedures (2). Note that for 300 nm features, deformation can be observed by slight contrast changes in the pens. Patterns were programmed in the instrument with tip-substrate contact times ranging from 125 to 500 ms for 300 nm and 1 μm features, respectively. Feature size and quality can be confirmed by sacrificing a portion of the substrate, etching Au in the unpatterned areas with a mixed aqueous solution of 13.3 mM Fe(NO₃)₃.9H₂O and 20 mM thiourea, and observing the results under an optical or scanning electron microscope.

After one week of growth on the patterned substrates, the levels of osteogenic markers expressed by the MSCs were analyzed using quantitative real-time reverse transcriptase polymerase chain reaction (qRT-PCR), Western blotting (WB), and immunofluorescence (IF) confocal microscopy.

### Quantitative RT-PCR (Primers)

Cells were harvested after one week of growth, and total RNA was extracted using TRIzol reagent (Invitrogen®) following manufacturer's recommended protocol. Approximately 1 μg of RNA was then reverse transcribed using Superscript® III (Invitrogen®). PCR was performed on the cDNA using LightCycler® 480 SYBR Green Master (Roche®) on a Roche Light Cycler® 480 II System following manufacturer's recommended protocol. The relative abundance of the mRNA levels for the genes investigated was normalized to GAPDH expression and compared to untreated cells to determine expression levels.

Primer Sequences 5′ → 3′

| Gene | | |
|---|---|---|
| Name | Forward | Reverse |
| Osteo- | GACTGTGACGAGTTGGCTGA | GCAAGGGGAAGAGGAAAGAA |
| calcin | | |
| Osteo- | CCAAGTAAGTCCAACGAAAG | GGTGATGTCCTCGTCTGTA |
| pontin | | |
| ALP | GGAACTCCTGACCCTTGACC | TCCTGTTCAGCTCGTACTGC |
| TAZ | TGAGCCCTTTCTAACCTGGCT | ATCTGTCACAAGAACGCAGGC |
| CBF-α | CCTCTGACTTCTGCCTCTGG | TATGGAGTGCTGCTGGTCTG |
| PPAR-γ | GCTGTTATGGGTGAAACTCTG | CTTGGACGTAGAGGTGGAATA |
| GAPDH | ACAGTCAGCCGCATCTTCTT | ACGACCAAATCCGTTGACTC |

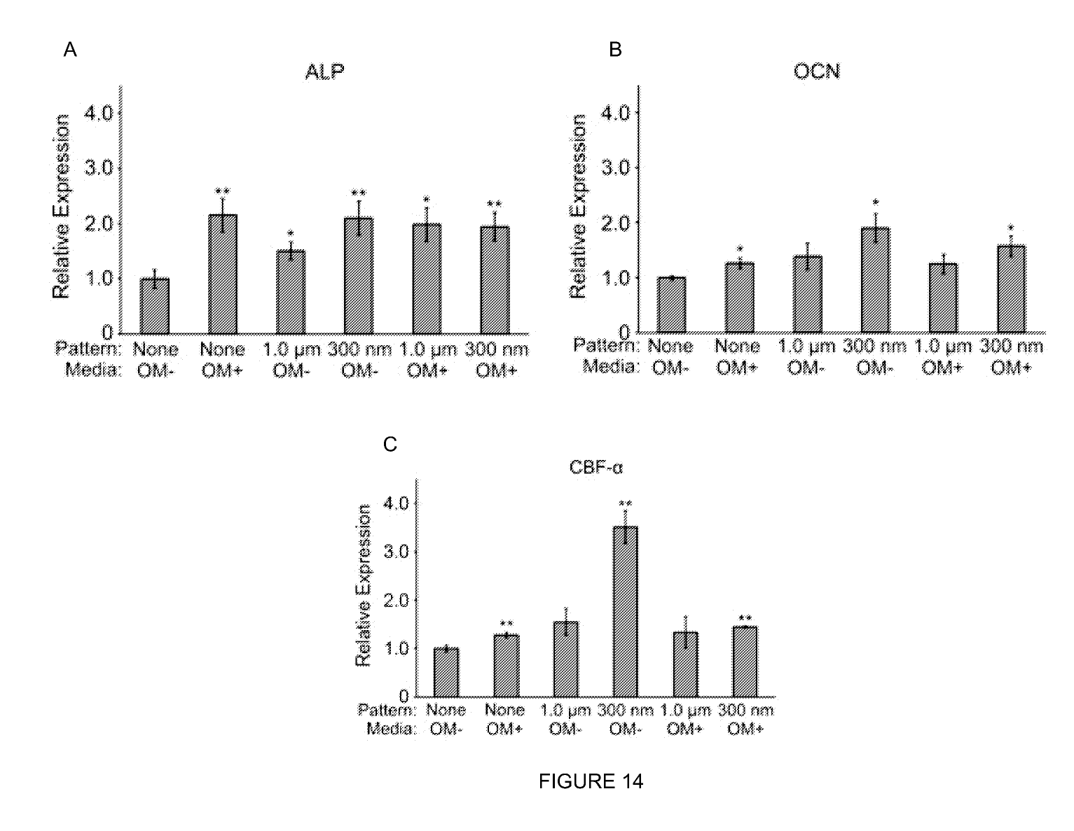

Following qRT-PCR analysis, cells grown on fibronectin patterns with 300 nm features in the absence of OM demonstrated a statistically significant increase in the expression levels of the osteogenic markers ALP, OCN, CBF-α and TAZ when compared to the control cells grown in the absence of patterns and OM (FIG. 14A-14C). Though the total surface area of fibronectin presented to the cells was held constant, the 1 μm feature sizes exhibited modest increases in the expression levels of the aforementioned osteogenic markers. Surprisingly, the cells grown on patterns consisting of 300 nm feature sizes expressed the osteogenic markers to a greater extent than even the positive control, cells grown in OM (FIG. 13). The combination of patterns with OM, however, led to a decrease in expression of osteogenic markers for OCN, CBF-α and TAZ, which may be explained by a previous study that showed a biphasic dependency of osteogenic marker expression on dexamethasone concentration (27). Below and above 10 nM dexamethasone, ALP activity decreased (27).

### Western Blotting

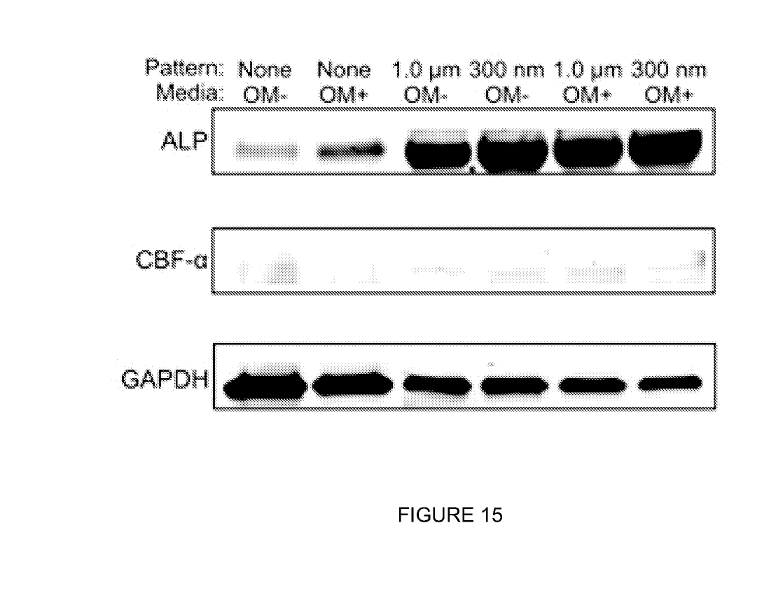

To confirm that the trends in protein levels match mRNA results, osteogenic markers were measured by WB (FIG. 15). Cells were collected one week after seeding on the patterns and lysed in mammalian cell lysis buffer (Thermo Scientific®) containing protease and phosphatase inhibitor (Thermo Scientific®). Proteins from total cell lysates were resolved with a 4-15% precast gradient gel (BioRad®), transferred to nitrocellulose membranes, blocked in 1% (w/v) casein in TBS, and blotted with primary antibodies for osteopontin (1:1000) (Abcam®), CBF-α (1:200) (Santa Cruz Biotechnology®), alkaline phosphatase (Santa Cruz Biotechnology®), GAPDH (1:200) (Santa Cruz Biotechnology®) and anti-mouse/rabbit IgG-AlexaFluor-680® (1:5000) secondary antibodies (Invitrogen®). The blots were detected by fluorescence detection method using the Odyssey® Infrared Imaging System (LI-COR Biosciences®) and quantified using ImageJ. Table 2 provides the quantification of relative protein levels by comparing the ratio of osteogenic marker to GAPDH and normalizing to the negative control (OM−NP)

TABLE 2

| | Pattern Feature Size: | | | | | |
|---|---|---|---|---|---|---|
| | None | None | 1.0 μm | 300 nm | 1.0 μm | 300 nm |
| Media: | OM− | OM+ | OM− | OM− | OM+ | OM+ |
| ALP | 1.0 | 2.6 | 8.9 | 11.5 | 12.5 | 17.1 |
| CBF-α | 1.0 | 1.5 | 1.2 | 1.6 | 1.8 | 2.2 |

OM− = cells cultured without osteogenic media
OM+ = cells cultured in osteogenic media

Consistent with the qRT-PCR findings, protein levels of MSCs cultured in the absence of OM showed increased osteogenic marker expression (ALP and CBF-α) especially for substrates having 300 nm features, but also those having 1 μm features (FIG. 14). Although the addition of OM decreased mRNA levels of CBF-α in patterned substrates (both 1 μm and 300 nm patterns), protein amounts from these samples remained comparable to cells cultured on patterned substrates without OM (FIG. 15). CBF-α mRNA and protein levels may not directly reflect similar trends because of post-transcriptional gene regulation that govern mRNA stability (29), post-translation protein modifications that activate the transcription factor (30), and protein half-life (31).

Though the mechanism by which cells transduce environmental signals is not completely understood, it has been observed previously that focal adhesions assemble into a range of sizes depending on the lineage of MSC differentiation (11). Embodiments of the disclosure not only provide a general tool for systematically studying populations of MSCs, but also demonstrates that nanoscale fibronectin patterns promote the expression of osteogenic markers in MSCs.

### Immunofluorescence and Confocal Microscopy

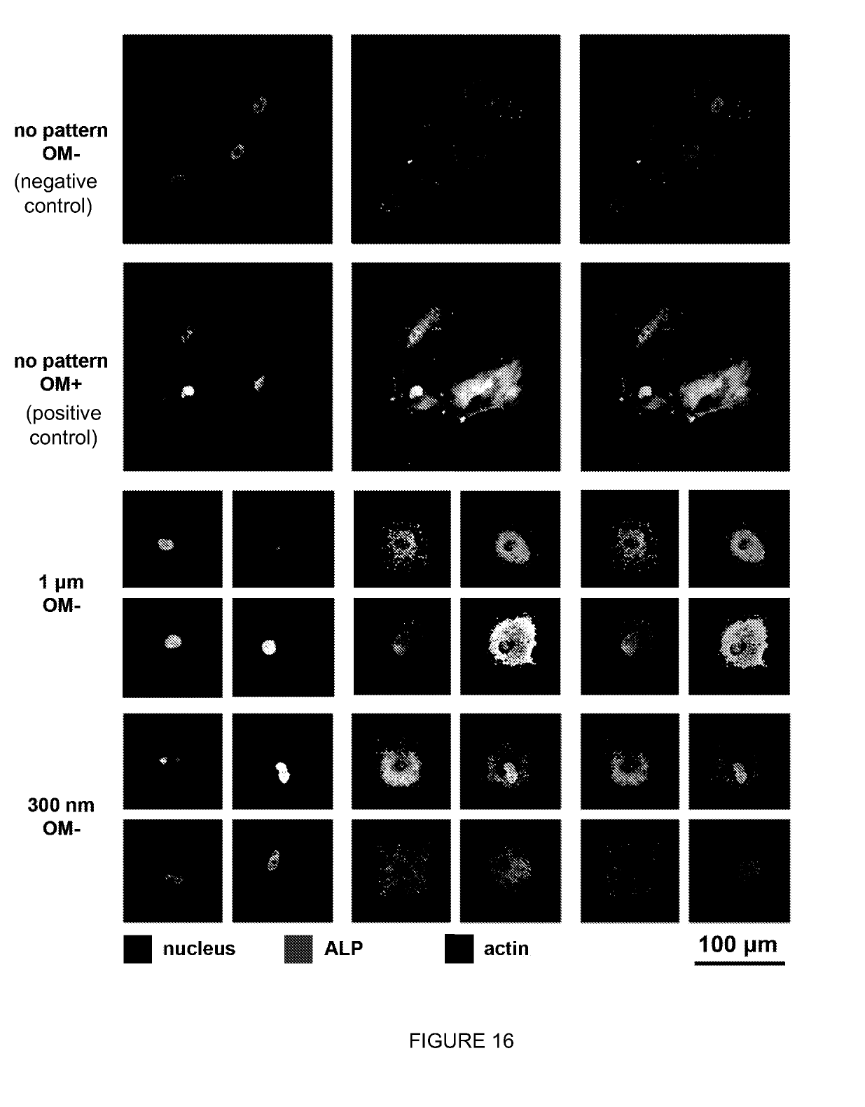

Referring to FIG. 16, after one week of growth on pattern substrates, the levels of osteogenic markers expressed by the MSCs were analyzed by immunofluorescence and confocal microscopy as well. These results are consistent with the quantitative RT-PCR results described above. Cells cultured on the patterned substrates were fixed in 3.7% paraformaldehyde/PBS for 15 minutes and then gently washed three times with PBS. Cells were premeabilized using 0.1% Triton X-100 in PBS solution with 2 mg/mL of bovine serum albumin for one minute before immersing in the primary antibody solution (rabbit anti-ALP, Santa Cruz Biotechnology®) in PBS overnight at 4° C. on a shaker. Samples were gently washed three times with PBS before incubation with the secondary antibody solutions (Invitrogen®, goat anti-rabbit; Invitrogen® goat anti-mouse) for one hour at room temperature. AlexaFluor568®-labeled phalloidin (Invitrogen®) was used according to manufacturer's instructions for actin staining. Samples were gently washed three times in PBS and then water before mounting onto glass slides using ProLong® Gold antifade reagent with DAPI (Invitrogen®). Cells were imaged using a Nikon® C-Si inverted laser confocal microscope.

### FAK-Phosphorylation

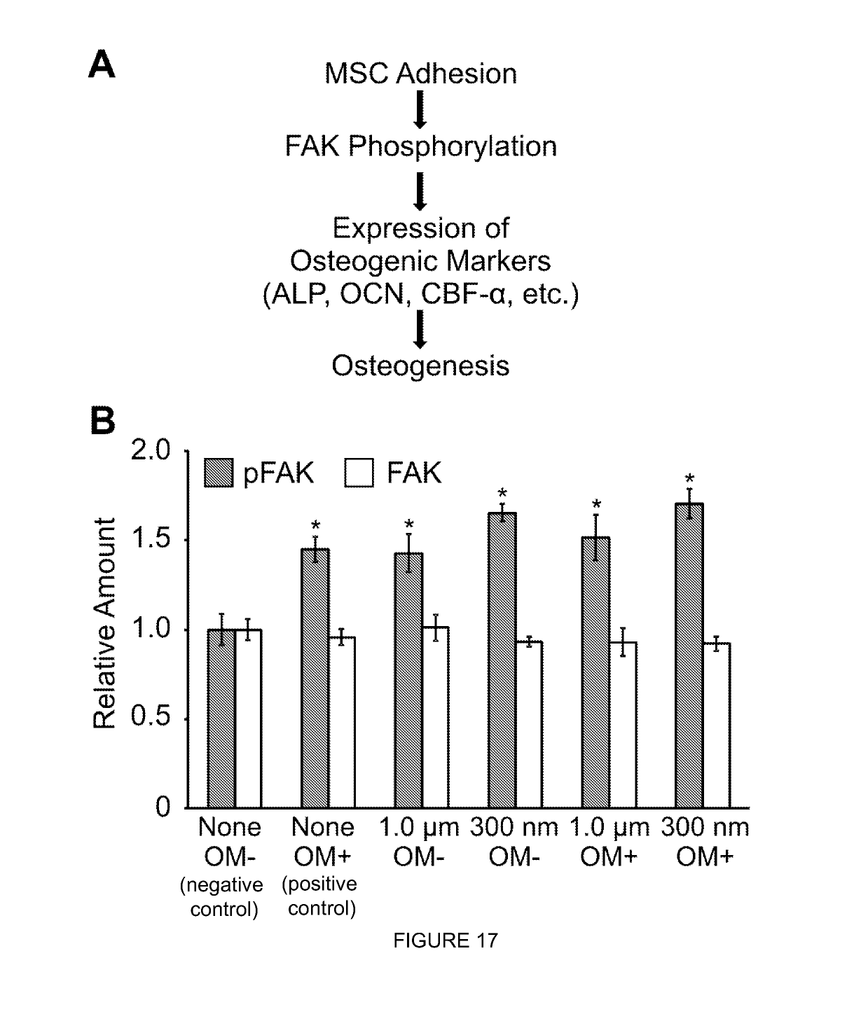

Auto-phosphorylation of FAK at tyrosine-397 occurs during cell adhesion and spreading in response to integrin engagement and clustering (32), which is important for interactions that activate downstream pathways involving Src-family non-receptor tyrosine kinase and extracellular signal-regulated kinase (ERK) proteins in somatic cells (FIG. 17A). In MSCs it has been observed that FAK phosphorylation, which can occur within hours and remain abundant for days, is necessary for and precedes osteogenic marker expression (e.g., CBF-α), which can occur after several days and increase in the following weeks of cell differentiation (33).

Consistent with qRT-PCR and Western blotting analysis at the one week time point, it is possible to measure the relative amount of phosphor-FAK to FAK by enzyme-linked immunosorbent assay (ELISA). The ratio of phosphor-FAK to FAK for patterned samples is over 1.5 times greater than the negative control (OM−NP), both in the absence and presence of OM (FIG. 17B). The negative control includes cells cultured in non-OM with no pattern present. The relative amount of phosphor-FAK to FAK for the 300 nm feature substrates without OM exceeded the positive control (OM+NP), which likely contributed to the observed increase in osteogenic markers. The positive control was cultured in OM with no pattern present. Consistent with the observed increases in osteogenic marker expression, the 300 nm features induced more FAK phosphorylation than the 1 μm features. The amount of FAK across all samples was statistically equivalent.

Using the methods of the disclosure, it has been demonstrated that, in the absence of OM containing chemical factors, patterned fibronectin substrates direct MSC differentiation towards osteogenic fates when compared to non-patterned fibronectin substrates. Furthermore, substrates having nanoscale features, optimized through the nanocombinatorics approach of the disclosure are more effective at inducing osteogenesis than microscale features, and for certain biomarks, even more effective than known OM.

Taken together, PPL can be used to systematically fabricate nanometer and micrometer scale biomolecular features on a surface over large areas and enable the investigation of size-dependent effects on MSC differentiation. Furthermore, this general technology can be applied to myriad biological systems to generate biochemical gradients and probe multivalent biomolecule interactions which may be relevant to fundamental biology, including cancer cell metastasis, neuron signalling, embryonic development, and tissue engineering.

The foregoing describes and exemplifies aspects of the invention, but is not intended to limit the invention defined by the claims which follow. All of the methods disclosed and claimed herein can be made and executed without undue experimentation in light of the present disclosure. While the materials and methods of this invention have been described in terms of specific embodiments, it will be apparent to those of skill in the art that variations may be applied to the materials and/or methods and in the steps or in the sequence of steps of the methods described herein without departing from the concept, spirit and scope of the invention. More specifically, it will be apparent that certain agents which are both chemically and physiologically related may be substituted for the agents described herein while the same or similar results would be achieved.

All patents, publications and references cited herein are hereby fully incorporated herein by reference. In case of conflict between the present disclosure and incorporated patents, publications and references, the present disclosure should control.

### REFERENCES

1. Ratner B D, Bryant S J (2004) Biomaterials: where we have been and where we are going. Annu Rev Biomed Eng 6:41-75.
2. Huo F, et al. (2008) Polymer pen lithography. Science 321:1658-1660.
3. Giam L R, Mirkin C A (2011) Cantilever-free scanning probe molecular printing. in Angew Chem Int Ed 50:7482-7485.
4. Zheng Z, et al. (2009) Multiplexed protein arrays enabled by polymer pen lithography: addressing the inking challenge. Angew Chem Int Ed 48:7626-7629.
5. Liao X, Braunschweig A B, Zheng Z J, Mirkin C A (2010) Force- and time-dependent feature size and shape control in molecular printing via polymer-pen lithography. Small 6:1082-1086.
6. Flaim C, Chien S, Bhatia S (2005) An extracellular matrix microarray for probing cellular differentiation. Nat Methods 2:119-125.
7. Mei Y, et al. (2010) Combinatorial development of biomaterials for clonal growth of human pluripotent stem cells. Nat Mater 9:768-778.
8. Gobaa S, et al. (2011) Artificial niche microarrays for probing single stem cell fate in high throughput. Nat Methods 8:949-955.
9. Mrksich M, Dike L, Tien J, Ingber D, Whitesides G (1997) Using microcontact printing to pattern the attachment of mammalian cells to self-assembled monolayers of alkanethiolates on transparent films of gold and silver. Exp Cell Res 235:305-313.
10. Csucs G, Kunzler T, Feldman K, Robin F, Spencer N (2003) Microcontact printing of macromolecules with submicrometer resolution by means of polyolefin stamps. Langmuir 19:6104-6109.
11. Engler A J, Sen S, Sweeney H L, Discher D E (2006) Matrix elasticity directs stem cell lineage specification. Cell 126:677-689.
12. Dalby M J, et al. (2007) The control of human mesenchymal cell differentiation using nanoscale symmetry and disorder. Nat Mater 6:997-1003.
13. McBeath R, Pirone D, Nelson C, Bhadriraju K, Chen C (2004) Cell shape, cytoskeletal tension, and RhoA regulate stem cell lineage commitment. Dev Cell 6:483-495.
14. Kilian K A, Bugarija B, Lahn B T, Mrksich M (2010) Geometric cues for directing the differentiation of mesenchymal stem cells. Proc Natl Acad Sci USA 107:4872-4877.
15. Li L, Klim J R, Derda R, Courtney A H, Kiessling L L (2011) Spatial control of cell fate using synthetic surfaces to potentiate TGF-α signaling. in Proc Natl Acad Sci USA, 108:11745-11750.
16. Lutolf M P, Gilbert P M, Blau H M (2009) Designing materials to direct stem-cell fate. Nature 462:433-441.
17. Pittenger M, et al. (1999) Multilineage potential of adult human mesenchymal stem cells. Science 284:143-147.
18. Geiger B, Bershadsky A, Pankov R, Yamada K (2001) Transmembrane extracellular matrix-cytoskeleton crosstalk. Nat Rev Mol Cell Bio 2:793-805.
19. Vogel V, Sheetz M (2006) Local force and geometry sensing regulate cell functions. Nat Rev Mol Cell Bio 7:265-275.
20. Kim D-H, Lee H, Lee Y K, Nam J-M, Levchenko A (2010) Biomimetic nanopatterns as enabling tools for analysis and control of live cells. in Adv Mater 22:4551-4566.
21. Dvir T, Timko B P, Kohane D S, Langer R (2011) Nanotechnological strategies for engineering complex tissues. Nat Nanotechnol 6:13-22.
22. Hong S, Baik K Y, Park S Y, Heo K, Lee K B (2011) Carbon nanotube monolayer cues for osteogenesis of mesenchymal stem cells. Small 7:741-745.
23. Liao X, Braunschweig A B, Mirkin C A (2010) “Force-feedback” leveling of massively parallel arrays in polymer pen lithography. Nano Lett 10:1335-1340.
24. Gmeiner B, Leibl H, Zerlauth G, Seelos C (1995) Affinity binding of distinct functional fibronectin domains to immobilized metal-chelates. Arch Biochem Biophys 321:40-42.
25. Schvartzman M, et al. (2011) Nanolithographic control of the spatial organization of cellular adhesion receptors at the single-molecule level. Nano Lett 11:1306-1312.
26. Chen C S, Mrksich M, Huang S, Whitesides G M, Ingber D E (1997) Geometric control of cell life and death. Science 276:1425-1428.
27. Jaiswal N, Haynesworth S, Caplan A, Bruder S (1997) Osteogenic differentiation of purified, culture-expanded human mesenchymal stem cells in vitro. J Cell Biochem 64:295-312.
28. Piner R, Zhu J, Xu F, Hong S, Mirkin C (1999) “Dip-pen” nanolithography. Science 283:661-663.
29. Gilbert L, et al. (2002) Expression of the osteoblast differentiation factor RUNX2 (Cbfa1/AML3/Pebp2αA) is inhibited by tumor necrosis factor-α. J Biol Chem 277:2695-2701.
30. Park O J, Kim H J, Woo K M, Baek J H, & Ryoo H M (2010) FGF2-activated ERK mitogen-activated protein kinase enhances Runx2 acetylation and stabilization. J Biol Chem 285:3568-3574.
31. Suh J H, Lee H W, Lee J W, & Kim J B (2008) Hes1 stimulates transcriptional activity of Runx2 by increasing protein stabilization during osteoblast differentiation. Biochem Biophys Res Comm 367:97-102.
32. Mitra S, Hanson D, & Schlaepfer D (2005) Focal adhesion kinase: in command and control of cell motility. Nat Rev Mol Cell Bio 6:56-68.
33. Salasznyk R M, Klees R F, Williams W A, Boskey A, & Plopper G E (2007) Focal adhesion kinase signaling pathways regulate the osteogenic differentiation of human mesenchymal stem cells. Exp Cell Res 313:22-37.

1. A method, comprising:
applying an analyte to a combinatorial pattern, the combinatorial pattern comprising pattern elements with a plurality of sizes and/or structures formed on a substrate using a tilted pen array;
identifying a pattern element size and/or structure having a desired effect on an analyte parameter using the analyte/combinatorial pattern combination; and
applying an analyte to a uniform pattern, the uniform pattern comprising pattern elements each having substantially the same size and/or structure corresponding to the identified pattern element size and/or structure formed on a substrate surface using a level pen array.

2. The method of claim 1, further comprising:
attaching an analyte interacting element on the pattern elements of the combinatorial pattern prior to applying the analyte to the combinatorial pattern; and
attaching an analyte interacting element on the pattern elements of the uniform pattern prior to application of an analyte to the uniform pattern.

3. The method of claim 2, wherein the analyte interacting element is selected from the group consisting of alkanethiols, peptide-functionalized thiols, N-hydroxysuccinimide esters, maleimides, amines, copper-catalyzed azide-alkynes, proteins, polypeptides, oligonucleotides, polysaccharides, and lipids.

4. The method of claim 1, wherein the pattern elements of the combinatorial pattern and the uniform pattern each comprise an alkanethiol, a protein, a peptide-functionalized thiol, a polypeptide, oligonucleotide, polysaccharide, and a pild.

5. The method of claim 1, wherein the analyte is a biomaterial.

6. The method of claim 5, wherein the biomaterial is a cell.

7. The method of claim 6, wherein the cell is a stem cell.

8. The method of claim 7, wherein the analyte parameter is selected from the group consisting of cell differentiation, cell attachment, cell viability, and cell osteogenic marker expression.

9. The method of claim 1 further comprising analyzing an effect of the identified pattern elements size and/structure on the analyte parameter using the analyte/uniform pattern combination.

10. The method of claim 9, wherein analyzing the effect of the identified pattern elements size comprises comparing the analyte parameter across pattern elements of the uniform pattern.

11. The method of claim 9, wherein analyzing the effect of the identified pattern elements size comprises comparing the analyte parameter resulting from the uniform pattern elements to an analyte parameter resulting from the analyte applied to a substrate having no pattern elements.

12. A method of analyzing an analyte, comprising
immobilizing an extracellular matrix protein on pattern elements of a combinatorial pattern, the combinatorial pattern comprising pattern elements with a plurality of sizes and/or structures formed on a substrate using a tilted pen array;
seeding a cell on the combinatorial pattern elements having the extracellular matrix protein immobilized thereon;
identifying a pattern element size and/or structure having a desired effect on a cell parameter using the seeded combinatorial pattern;
forming a uniform pattern comprising pattern elements each having substantially the same size and/or structure corresponding to the identified pattern element size and/or structure;
immobilizing an extracellular matrix protein on pattern elements of uniform pattern, the uniform pattern comprising pattern elements having substantially the same size and/or structure corresponding to the identified pattern element size and/or structure formed by a level pen array; and
seeding a cell on the uniform pattern elements having the extracellular matrix protein immobilized thereon.

13. The method of claim 12, wherein the cell parameter is selected from the group consisting of cell differentiation, cell attachment, cell viability, and cell osteogenic marker expression.

14. The method of claim 13, wherein:
the cell parameter is cell differentiation,
identifying the pattern element size and/or structure using the seeded combinatorial pattern comprises identifying a pattern element size and/or structure in which the cells attach to the extracellular matrix protein.

15. The method of claim 12, further comprising analyzing an effect of the identified pattern element size and/or structure on the cell parameter using the seeded uniform pattern.

16. The method of any one of claim 15, wherein analyzing the effect of the identified pattern element size comprises comparing the cell parameter across the uniform pattern elements.

17. The method of claim 15, wherein analyzing the effect of the identified pattern size and/or structure comprises comparing the cell parameter resulting from the uniform pattern elements to a cell parameter resulting from applying the cell to a substrate having no pattern elements.

18. The method of claim 15, wherein the cell parameter is cell differentiation and analyzing the effect of the identified pattern element size and/or structure comprises comparing protein and transcription factor markers indicative of osteogenic commitment

19. The method of claim 18, wherein the protein and transcription factor markers include one or more of alkaline phosphatase, osteocalcin, osteopontin, core-binding factor-α, and transcriptional coactivator with PDZ-motif.

20. The method of claim 12, wherein the cell is a stem cell.

21. The method of claim 20, wherein the stem cell is a mesenchymal stem cell.

22. The method of claim 1, wherein the pattern elements of one or both of the combinatorial pattern and the uniform pattern comprise 16-mercaptohexadecanoic acid.

23. The method of claim 1, further comprising forming the combinatorial pattern by:
choosing a tilt geometry for a pen array with respect to a substrate surface,
the tilt geometry being in reference to a substrate surface and comprising a first angle of the pen array with respect to a first axis of the substrate and a second angle of the pen array with respect to a second axis of the substrate, the first and second axes being parallel to the substrate surface and perpendicular to one another, at least one of the first and second angles being non-zero, wherein a leveled position with respect to the substrate surface comprises first and second angles both equaling 0°, and
the pen array comprising a plurality of tips fixed to a common substrate layer, the tips and the common substrate layer being formed from an elastomeric polymer or elastomeric gel polymer, and the tips having a radius of curvature of less than about 1 μm;
inducing the tilt geometry between the pen array and the substrate surface by the chosen first and second angles; and
forming the combinatorial pattern having pattern elements on the substrate surface with the titled pen array, whereby the size of the pattern elements varies across the substrate surface along the tilted axis or axes.

24. The method of claim 1, further comprising forming the combinatorial pattern by:
choosing a range of pattern element sizes for a pattern to be formed on a substrate surface;
choosing, based on a theoretical model, a tilt geometry for a pen array with respect to the substrate surface to achieve the chosen range of pattern element sizes,
the tilt geometry being in reference to a substrate surface and comprising a first angle of the pen array with respect to a first axis of the substrate and a second angle of the pen array with respect to a second axis of the substrate, the first and second axes being parallel to the substrate surface and perpendicular to one another, at least one of the first and second angles being non-zero, wherein a leveled position with respect to the substrate surface comprises first and second angles both equaling 0°, and
the pen array comprising a plurality of tips fixed to a common substrate layer, the tips and the common substrate layer being formed from an elastomeric polymer or elastomeric gel polymer, and the tips having a radius of curvature of less than about 1 μm;
inducing the tilt geometry between the pen array and the substrate surface by the chosen first and second angles; and
forming the combinatorial pattern having pattern elements on the substrate surface with the titled pen array, whereby the size of the formed pattern elements varies across the substrate surface along the tilted axis or axes and comprises the chosen range of pattern element sizes.

25. The method of claim 24, wherein the theoretical model predicts a pattern element size generated by each tip based a combination of the first and second angles, a spacing between tips of the tip array, an edge length of a top surface of the tip, an edge length at a bottom surface of the tip, a height of the tip, a compression modulus of the elastomeric polymer, a number of tips from a first tip to contact the substrate surface spaced from the first tip in the first axis, and a number of tips from a first tip to contact the substrate surface spaced from the first tip in the second axis.

26. The method of claim 23, comprising inducing the tilt geometry between the pen array and the substrate surface by tilting the pen array and maintaining the substrate surface stationary.

27. The method of claim 26, comprising tilting the pen array by providing a motor-controlled, multi-axis stage attached to the pen array, and controlling the degree of extension of one or more motors to induce the desired tilt angles.

28. The method of claim 23, comprising inducing a tilt geometry comprising either or both of the first and second angles in a range of −20° to 200.

29. The method of claim 23, comprising inducing a tilt geometry comprising either or both of the first and second angles in a range of −6° to 60.

30. The method of claim 23, comprising choosing one of the first and second angles to be 0°.

31. The method of claim 23, further comprising forming the uniform pattern using the pen array by inducing a tilt geometry comprising both the first and second angles as non-zero values.

32. The method of claim 1, further comprising forming the combinatorial pattern by coating the tilted pen array with a patterning composition and contacting the substrate surface with the tilted pen array to deposit the patterning composition onto the substrate surface and form the combinatorial pattern elements.

33. The method of claim 32, comprising contacting the substrate surface with the tilted pen array such that all of the tips of the pen array contact the substrate surface and deform, whereby deformation of the tips varies across the pen array along the tilted axis or axes.

34. The method of claim 32, wherein the patterning composition comprises a biomaterial having an activity, and further comprising selecting a patterning composition formulation to preserve the activity of the biomaterial when depositing the patterning composition onto the substrate surface.

35. The method of claim 32, wherein the patterning composition comprises 16-mercaptohexadecanoic acid.

36. The method of claim 32, wherein the patterning composition is free of exogenous patterning composition carriers.

37. The method of claim 32, wherein the coating step comprises adsorbing and/or absorbing the patterning composition onto the tip array.

38. The method of claim 32, wherein the size of the pattern elements differs by a value in a range of about 10 nm to about 1000 nm.

39. The method of claim 32, wherein adjacent tips of the pen array have a tip-to-tip spacing and thereby forming a spacing between adjacent pattern elements substantially equal to the tip-to-tip spacing between adjacent tips of the pen array.

40. The method of claim 1, wherein the tips are pyramidal.

41. The method of claim 1, wherein the tips are arranged in a regular periodic pattern.

42. The method of claim 1 comprising leveling the pen array to the leveled position with respect to the substrate surface prior to inducing the tilt geometry.

43. The method of claim 1, wherein the tilted pen array comprises a pen array oriented in a tilted position relative to the substrate surface for the combinatorial pattern and the level pen array comprises the same pen array oriented in a leveled position relative to the substrate surface for the uniform pattern.


SEQUENCE LISTING (14 sequences)

SEQ ID NO: 1 - DNA, 20 bp, Artificial Sequence
  Synthetic primer
gactgtgacgagttggctga

SEQ ID NO: 2 - DNA, 20 bp, Artificial Sequence
  Synthetic primer
gcaaggggaagaggaaagaa

SEQ ID NO: 3 - DNA, 20 bp, Artificial Sequence
  Synthetic primer
ccaagtaagtccaacgaaag

SEQ ID NO: 4 - DNA, 19 bp, Artificial Sequence
  Synthetic primer
ggtgatgtcctcgtctgta

SEQ ID NO: 5 - DNA, 20 bp, Artificial Sequence
  Synthetic primer
ggaactcctgacccttgacc

SEQ ID NO: 6 - DNA, 20 bp, Artificial Sequence
  Synthetic primer
tcctgttcagctcgtactgc

SEQ ID NO: 7 - DNA, 21 bp, Artificial Sequence
  Synthetic primer
tgagccctttctaacctggct

SEQ ID NO: 8 - DNA, 21 bp, Artificial Sequence
  Synthetic primer
atctgtcacaagaacgcaggc

SEQ ID NO: 9 - DNA, 20 bp, Artificial Sequence
  Synthetic primer
cctctgacttctgcctctgg

SEQ ID NO: 10 - DNA, 20 bp, Artificial Sequence
  Synthetic primer
tatggagtgctgctggtctg

SEQ ID NO: 11 - DNA, 21 bp, Artificial Sequence
  Synthetic primer
gctgttatgggtgaaactctg

SEQ ID NO: 12 - DNA, 21 bp, Artificial Sequence
  Synthetic primer
cttggacgtagaggtggaata

SEQ ID NO: 13 - DNA, 20 bp, Artificial Sequence
  Synthetic primer
acagtcagccgcatcttctt

SEQ ID NO: 14 - DNA, 20 bp, Artificial Sequence
  Synthetic primer
acgaccaaatccgttgactc